(19) United States
(12) Patent Application Publication
(10) Pub. No.: US 2015/0082673 A1
(43) Pub. Date: Mar. 26, 2015

(54) METHOD AND DEVICES FOR DISPLAYING IMAGES

(71) Applicant: Silas Jeffrey Durant, Scottdale, GA (US)

(72) Inventor: Silas Jeffrey Durant, Scottdale, GA (US)

(21) Appl. No.: 14/450,185

(22) Filed: Aug. 1, 2014

Related U.S. Application Data
(60) Provisional application No. 61/861,113, filed on Aug. 1, 2013.

(51) Int. Cl. G09F 9/00

(52) U.S. Cl. CPC G09F 9/00
USPC 40/446

(57) ABSTRACT

Disclosed herein are methods and devices for displaying images. In one aspect, the system comprises (a) a display device having an image disposed on a surface thereof; and (b) a screening device overlying at least a portion of the display device and comprising an image filter element and a transparent image pass through element; wherein the screening device can be selectively positioned in a first configuration such that a desired portion of the image is viewable through the transparent image pass through element.

### CROSS REFERENCE TO RELATED APPLICATIONS

This claims the benefit of priority to U.S. Provisional Patent Application Ser. No. 61/861,113, filed Aug. 1, 2013, which is hereby incorporated herein by reference in its entirety.

### FIELD OF INVENTION

The present invention relates to methods and systems for displaying images.

### BACKGROUND OF THE INVENTION

Over the past several decades, visual media has become the predominant mode of conveying information because of its effectiveness at capturing and maintain an audience's attention. In particular, recent visual media has focused on interactive media, such as video, computer games, and video games, because of its superior ability to attract and maintain viewers' attention. Interactive media presents successive images to create the illusion of movement. To this end, the motion aspect of interactive media triggers an involuntary response from the viewer's eye to investigate and discover the source. Accordingly, visual media that can produce this type of interaction between the viewer and the image is more likely to capture and maintain the attention of the viewer.

As this type of dynamic, interactive media continues to become commonplace, less attention will be paid to traditional, static media, such as still photographs and prints. Accordingly, there remains a need for new methods and devices for displaying images, that is interactive and can capture a viewer's attention. This need and other needs are satisfied by the various aspects of the present disclosure.

### SUMMARY OF THE INVENTION

In accordance with the purposes of the invention, as embodied and broadly described herein, the invention, in one aspect, relates to devices and methods for displaying an image. In a further exemplary aspect, the invention relates to a system comprising: a) a display device having an image disposed on a surface thereof; and b) a screening device overlying at least a portion of the display device and comprising an image filter element and a transparent image pass through element; wherein the screening device can be selectively positioned in a first configuration such that a desired portion of the image is viewable through the transparent image pass through element.

In another exemplary aspect, the invention relates to a method for displaying an image, the method comprising: a) providing a display device having an image disposed on a surface thereof; and b) overlying a screening device on at least a portion of the display device; wherein the screening device comprises an image filter element and a transparent image pass through element, and wherein the screening device can be selectively positioned in a first configuration such that a desired portion of the image is viewable through the transparent image pass through element.

In further aspects, the invention also relates to articles and assemblies employing the disclosed systems and methods.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several aspects of the invention and together with the description, serve to explain the principles of the invention.

FIGS. 1A-1D show an exemplary embodiment of a display system of the present invention.

FIG. 1A shows a screening device of the present invention.

FIG. 1B shows a display device having a composite image

FIG. 1C shows a screening device selectively positioned over a display device in a first configuration.

FIG. 1D shows a screening device selectively positioned over a display device in a second configuration.

FIGS. 2A-2B shows an exemplary embodiment of a display system of the present invention.

FIG. 2A shows a perspective of a screening device selectively positioned over a display device in a first configuration.

FIG. 2B shows a perspective of a screening device selectively positioned over a display device in a second configuration.

FIGS. 3A-3B shows another exemplary embodiment of a display system of the present invention.

FIG. 3A shows an exemplary screening device of the present invention.

FIG. 3B shows an exemplary display device having a composite image.

FIG. 4A-4D show another exemplary embodiment of the present invention.

FIG. 4A shows a screening device selectively positioned over a display device in a first configuration.

FIG. 4B shows a screening device selectively positioned over a display device in a second configuration.

FIG. 4C shows a screening device selectively positioned over a display device in a third configuration.

FIG. 4D shows a screening device selectively positioned over a display device in a fourth configuration.

FIG. 5 shows a magnified view of the screening device (top) being selectively positioned over the display device (bottom).

FIGS. 6A-6D show another exemplary embodiment of a display system of the present invention.

FIG. 6A shows a display device having a composite image.

FIG. 6B shows a screening device of the present invention.

FIG. 6C shows the screening device selectively positioned over a display device in a first configuration.

FIG. 6D shows the screening device selectively positioned over a display device in a second configuration.

FIG. 7A shows a magnified view of the screening device positioned over the display device in a first configuration.

FIG. 7B shows a magnified view of the screening device positioned over the display device in a second configuration.

FIG. 8 shows a magnified view of the screening device positioned over the display device in a third configuration.

FIG. 9 shows a magnified view of the screening device positioned over the display device in a fourth configuration.

FIGS. 10A-10B show another embodiment of a display system of the present invention.

FIG. 10A shows a screening device of the present invention.

FIG. 10B shows a display device having a interlaced composite image.

FIGS. 11A-11C show additional aspects of an exemplary embodiment of a display device of the present invention.

FIG. 11A shows the screening device selectively positioned over a display device in a first configuration.

FIG. 11B shows the screening device selectively positioned over a display device in a second configuration.

FIG. 11C shows the screening device selectively positioned over a display device in a third configuration.

FIGS. 12A-12D show another exemplary embodiment of a display system of the present invention.

FIG. 12A shows a screening device (top) and a display device (bottom) having a composite image.

FIG. 12B shows the screening device selectively positioned over the display device in a first configuration.

FIG. 12C shows the screening device selectively positioned over the display device in a second configuration.

FIGS. 13A and 13B show another exemplary embodiment of a display system of the present invention.

FIG. 13A shows a screening device depicted as a product label of a product package.

FIG. 13B shows a display device having a composite image depicted as a product label of a product package.

FIGS. 14A and 14B show additional aspects of an exemplary embodiment of a display device of the present invention depicted as product labeling.

FIG. 14A shows a screening device label selectively positioned over the display device in a first configuration.

FIG. 14B shows a screening device label selectively positioned over the display device in a second configuration.

FIGS. 15A and 15B show additional aspects of an exemplary embodiment of a display system of the present invention depicted as product packaging.

FIG. 15A shows a screening device depicted as a product label.

FIG. 15B shows a screening device depicted as a product sleeve.

FIGS. 16A and 16B show additional aspects of an exemplary embodiment of a display system of the present invention depicted as product packaging.

FIG. 16A shows a display device having a composite image depicted as a product label.

FIG. 16B shows a display device having a composite image depicted as a product label.

FIGS. 17A-17D show another exemplary embodiment of a display system of the present invention depicted as product packaging.

FIG. 17A shows a screening device configured as a sleeve.

FIG. 17B shows a display device configured in a cylindrical shape.

FIG. 17C shows a screening device label selectively positioned over a display device in a first configuration.

FIG. 17D shows a screening device label selectively positioned over a display device in a second configuration.

FIG. 18 shows another exemplary embodiment of a display system of the present invention depicted as bottle packaging.

FIGS. 19A and 19B show another exemplary embodiment of a display system of the present invention depicted as a product display.

FIG. 19A shows a display device having a composite image.

FIG. 19B shows a scrolling screening device according to the present invention.

FIG. 20 shows a scrolling screening device positioned over a display device.

FIGS. 21A and 21B show another exemplary embodiment of a display system of the present invention depicted for product packaging.

FIG. 21A shows a screening device depicted as a product label.

FIG. 21B shows a display device having a composite depicted as a product label.

FIG. 22A shows a screening device label selectively positioned over a display device in a first configuration.

FIG. 22B shows a screening device label selectively positioned over a display device in a second configuration.

FIGS. 23A-23D show another exemplary embodiment of a display system of the present invention depicted as product packaging.

FIG. 23A shows a display device having composite image.

FIG. 23B shows a screening device according to the present invention.

FIG. 23C shows a screening device selectively positioned over the display device in a first configuration.

FIG. 23D shows the screening device selectively positioned over the display device in a second configuration.

FIGS. 24A-24D shows another exemplary embodiment of a display system of the present invention depicted as product packaging.

FIG. 24A shows a display device depicted as a product label.

FIG. 24B shows a screening device depicted as a product label.

FIG. 24C shows a screening device selectively positioned over a display device in a first configuration.

FIG. 24D shows a screening device selectively positioned over a display device in a second configuration.

FIG. 25 shows another exemplary embodiment of a display system depicted as bottle packaging.

FIGS. 26A-26C shows another exemplary embodiment of a display system of the present invention depicted as product packaging.

FIG. 26A shows a screening device depicted as outer product packaging.

FIG. 26B shows a display device depicted as inner product packaging.

FIG. 26C shows a screening device selectively positioned over a display device in a first configuration.

FIG. 27 shows an exemplary screening device according to the present invention.

### DETAILED DESCRIPTION OF THE INVENTION

The present invention can be understood more readily by reference to the following detailed description of the invention and the Examples included therein.

Before the present articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

All publications mentioned herein are incorporated herein by reference to disclose and describe the methods and/or materials in connection with which the publications are cited.

### A. DEFINITIONS

It is also to be understood that the terminology used herein is for the purpose of describing particular aspects only and is not intended to be limiting. As used in the specification and in the claims, the term “comprising” can include the aspects “consisting of” and “consisting essentially of” Unless defined otherwise, all technical and scientific terms used herein have the same meaning as commonly understood by one of ordinary skill in the art to which this invention belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “an image” includes two or more images.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific aspect or combination of aspects of the methods of the invention.

As used herein, the term or phrase “effective,” “effective amount,” or “conditions effective to” refers to such amount or condition that is capable of performing the function or property for which an effective amount is expressed. As will be pointed out below, the exact amount or particular condition required will vary from one aspect to another, depending on recognized variables such as the materials employed and the processing conditions observed. Thus, it is not always possible to specify an exact “effective amount” or “condition effective to.” However, it should be understood that an appropriate effective amount will be readily determined by one of ordinary skill in the art using only routine experimentation.

As used herein, the term “image,” refers to video images and still images unless the context clearly dictates otherwise. Thus, for example, reference to “an image” includes still prints or sequential frames from video.

It is understood that the devices and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. DISPLAY SYSTEMS

As briefly described above, the present disclosure relates, in one aspect, to a system comprising, a) a display device having an image disposed on a surface thereof; and b) a screening device overlying at least a portion of the display device and comprising an image filter element and a transparent image pass through element; wherein the screening device can be selectively positioned in a first configuration such that a desired portion of the image is viewable through the transparent image pass through element.

In various aspects, the screening device comprises multiple configuration positions. In further aspects, each configuration position can produce a different visual image. For example, according to still further aspects, the screening device can be selectively positioned in a second configuration such that a second desired portion of the image is viewable through the transparent image pass through element. In yet further aspects, the screening device can be selectively positioned in a second configuration such that a desired portion of the image is not viewable through the transparent image pass through element.

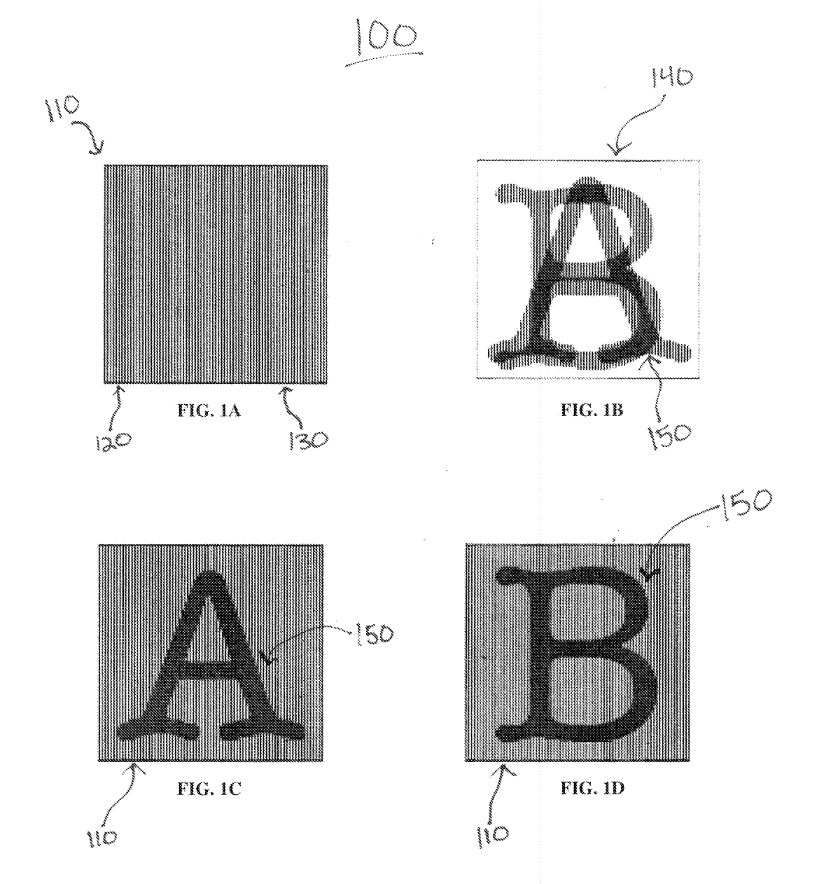

As seen in FIGS. 1A-1D, an exemplary embodiment of a display system 100 of the present invention is illustrated. In one aspect, FIG. 1A shows a screening device 110 comprising a plurality of alternating image filter elements 120 and transparent image pass through elements 130. In a further aspect, FIG. 1B shows a display device 140 having a composite image 150 comprising an image of the letter “A” interlaced with an image of the letter “B.” In a still further aspect, FIG. 1C shows the screening device 110 selectively positioned in a first configuration with respect to display device 140 of FIG. 1B such that only the letter “A” portion of composite image 150 is viewable through the transparent image pass through element 130. In a yet further aspect, FIG. 1D shows the screening device 110 selectively positioned in a second configuration with respect to display device 140 of FIG. 1B such that only the letter “B” portion of the composite image 150 is viewable through the transparent image pass through element.

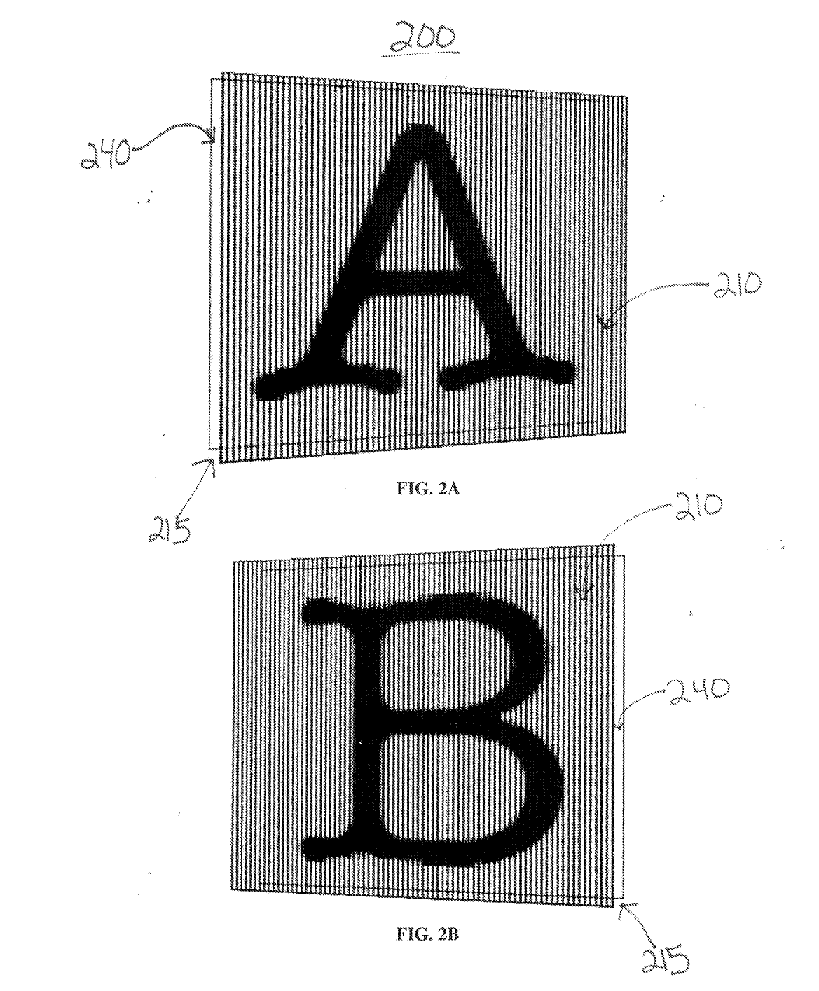

In a further aspect, FIGS. 2A and 2B show another exemplary embodiment of a display system 200 of the present invention, wherein the screening device 210 is fixed and spaced a predetermined distance 215 from the display device 240 illustrating two alternating images on two planes. In one aspect, FIG. 2A shows the viewer viewing the screening device from a first configuration position such that only the portion of the letter “A” image is viewable through the transparent image pass through element. In a further aspect, FIG. 2B shows the viewer viewing the screening device from a second configuration position such that only the portion of the letter “B” image is viewable through the transparent image pass through element.

In some aspects, the display device can comprise a composite image comprising at least two images. In further aspects, the display device can comprise at least three images. For example, in still further aspects, the display device can have at least two visual images disposed on a surface thereof and wherein the screening device can be selectively positioned in a first configuration such that a first of the at least two images is viewable through the transparent image pass through element and a second of the at least two images is not viewable through the transparent image pass through element. In a yet further aspect, the screening device can be selectively positioned in a second configuration such that the second of the at least two images is viewable through the transparent image pass through element and the first of the at least two images is not viewable through the transparent image pass through element.

In other aspects, the display device can comprise a composite image comprising at least one fixed image and at least one video image. For example, in further aspects, the display device can have at least one fixed image interlaced with at least one video disposed on a surface thereof and wherein the screening device can be selectively positioned in a first configuration such that the at least one fixed image is viewable through the transparent image pass through element and the at least one video image is not viewable through the transparent image pass through element. In a yet further aspect, the screening device can be selectively positioned in a second configuration such that the at least one video image is viewable through the transparent image pass through element and the at least one fixed image is not viewable through the transparent image pass through element. In an even further aspect, the video image is not static, and will change based on the video format and/or frame rate.

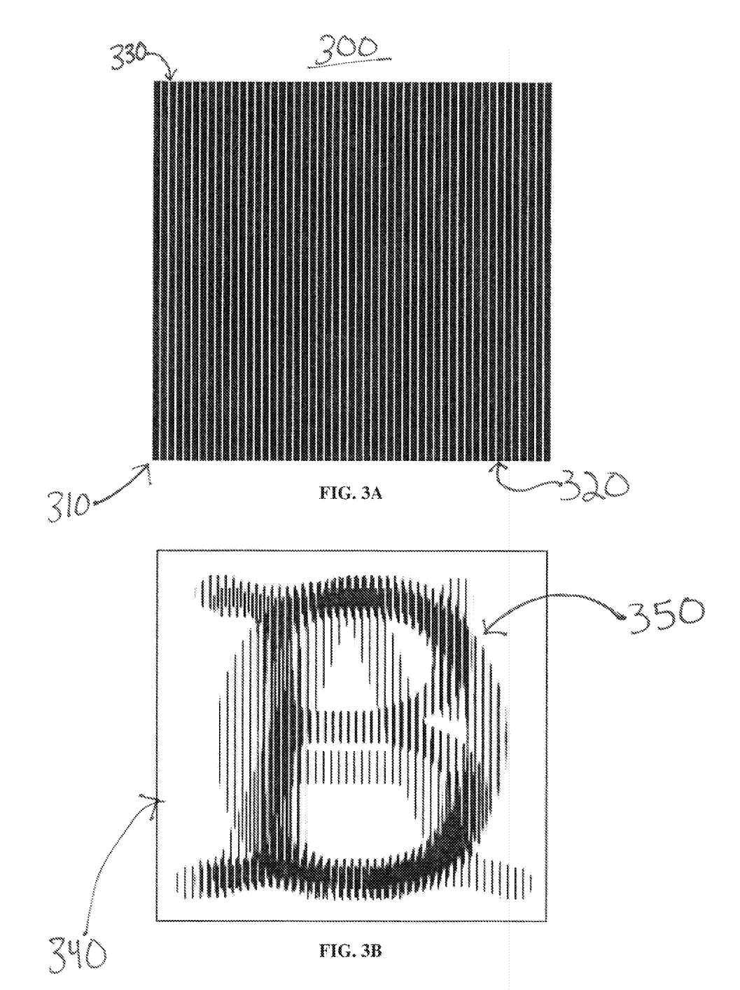

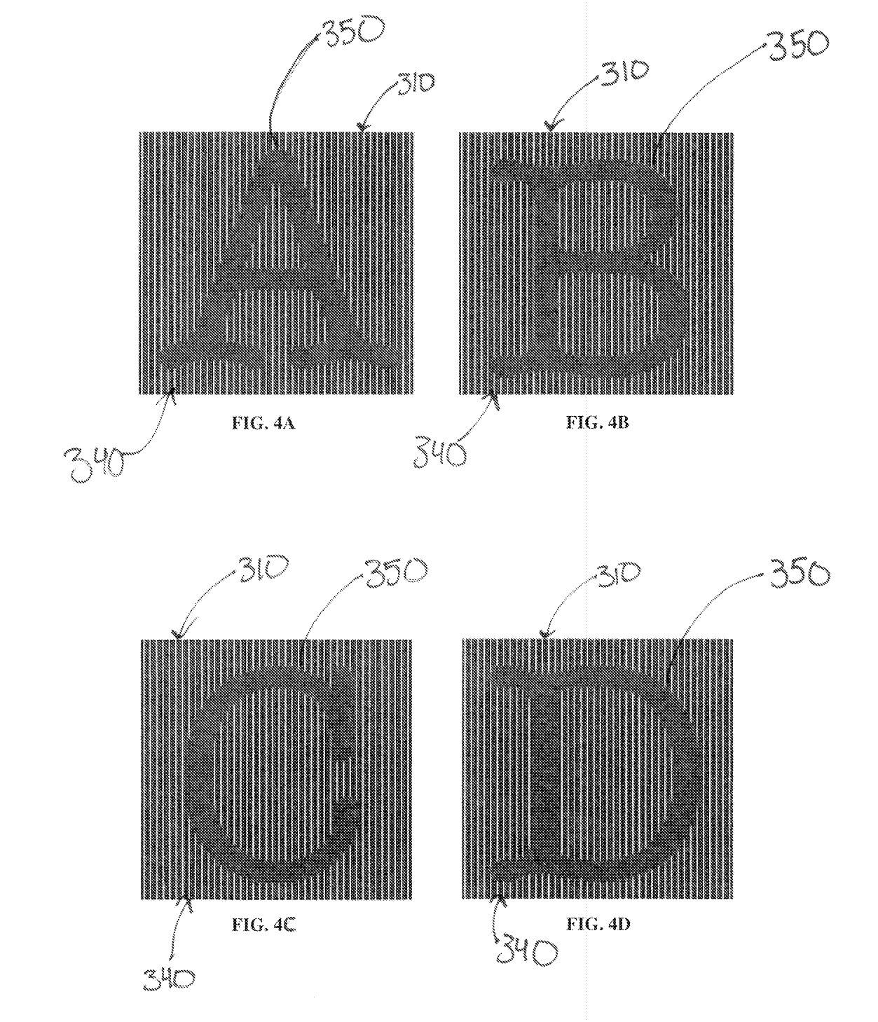

Referring now to FIGS. 3A and 3B, another exemplary embodiment of a display system 300 of the present invention is shown. In one aspect, FIG. 3A shows a screening device 310 comprising a plurality of alternating image filter elements 320 and transparent image pass through elements 330. In a further aspect, FIG. 3B shows a display device 340 having a composite image 350 comprising four interlaced images comprising the letter “A”, the letter “B”, the letter “C”, and the letter “D.” In other aspects, each of the plurality of interlaced letters can then be made viewable by selectively positioning the screening device 300 such that a desired interlaced letter is selectively viewable from the interlaced composite image. In still further aspects, the selected letter is made viewable through the transparent pass through element 330 and the remaining interlaced letters are not viewable through the transparent pass through element. For example, in one aspect, FIG. 4A shows the screening device 310 selectively positioned in a first configuration with respect to display device 340 such that only the letter “A” portion of the composite image 350 is viewable through the transparent image pass through element. In a further aspect, FIG. 4B shows the screening device 310 selectively positioned in a second configuration with respect to display device 340 such that only the letter “B” portion of the composite image 350 is viewable through the transparent image pass through element. In a still further aspect, FIG. 4C shows the screening device 310 selectively positioned in a third configuration with respect to display device 340 such that only the letter “C” portion of the composite image 350 is viewable through the transparent image pass through element. In a yet further aspect, FIG. 4D shows the screening device 310 selectively positioned in a fourth configuration with respect to the display device 340 such that only the letter “D” portion of composite image 350 is viewable through the transparent image pass through element. In some aspects, the source images used to produce the interlaced composite image can comprise text, symbols, logos, or marks, or combinations thereof. In other aspects, the source images used to produce the interlaced composite image can comprise different photographs or images.

In further aspects, the composite image comprises at least two images, wherein the at least two images are interlaced. In still further aspects, any number of a plurality of images can be interlaced to provide a composite image. In yet further aspects, the composite image is disposed on a surface of the display device.

In further aspects, each of the plurality of interlaced images can then be made viewable by selectively positioning the screening device such that a desired interlaced image is selectively viewable from the interlaced composite image. In still further aspects, the selected image is made viewable through the transparent pass through element and the remaining interlaced images are not viewable through the transparent pass through element. In yet further aspects, selectively positioning comprises subjecting the interlaced composite image to a plurality of transparent image pass through elements, each of which are preselected to reveal a desired source image.

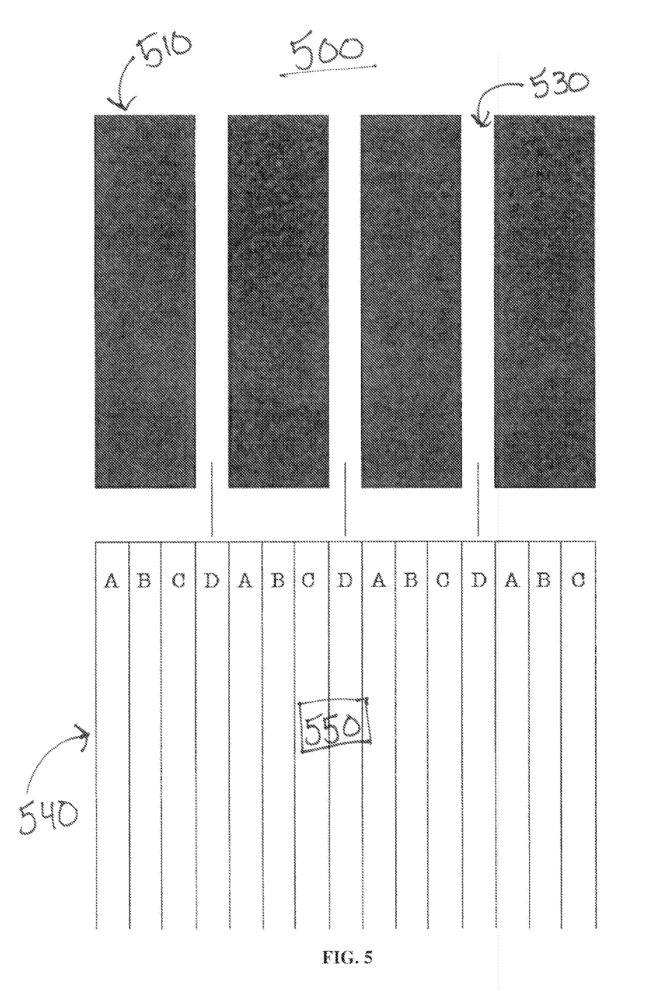

Referring now to FIG. 5, another aspect of an exemplary embodiment of a display system 500 of the present invention is illustrated. In one aspect, FIG. 5 shows a magnified view of the screening device 510 (top) being selectively positioned over the display device 540 (bottom) in a configuration such that only the letter “D” portion of composite image 550 will be viewable through the transparent image pass through element. In a further aspect, the information in the composite image is repeated, and is represented by the letters “A”, “B”, “C”, and “D”. In a yet further aspect, the width of the transparent image pass through element 530 is equal to width of the portion of the selected image, such that only the portion of the selected image is viewable through the transparent image pass through element.

In some aspects, the screening device configuration position can be switched in a sequence of configuration positions causing a corresponding images to be displayed in rapid sequence. In further aspects, the rapid switching between configuration positions can impart a sense of movement to the viewer. In other aspects, the display device and screening device can remain fixed and a viewer's position can cause a corresponding image to be displayed by the screening device. In further aspects, the rapid change of the viewer's position can also cause switching between configuration positions, also imparting a sense of movement to the viewer. In still further aspects, the rate and pace of switching between configuration positions can vary based on the configuration of the display system.

In other aspects, the screening device can comprise any desired ratio of image filter elements and transparent image pass through elements. In some aspects, the screening device can comprise a ratio of image filter elements to transparent image pass through elements of from 8:1 to 1:8, including exemplary ratios of 7:1, 6:1, 5:1, 4:1, 3:1, 2:1, 1:1, 1:2, 1:3, 1:4, 1:5, 1:6, and 1:7. In further aspects, the image filter elements and transparent image pass through elements can each independently have varying widths, for example, about 1 mm, 1 cm, 1 in, 1 ft., 1 m, 1 yd., or more.

In some aspects, the plurality of lines comprising an interlaced image are not equally spaced or parallel. In further aspects, the interlaced composite image can comprise at least a first image comprising a plurality of curved lines of varying widths. In other aspects, the screening device is a mirror image of the image of the display device.

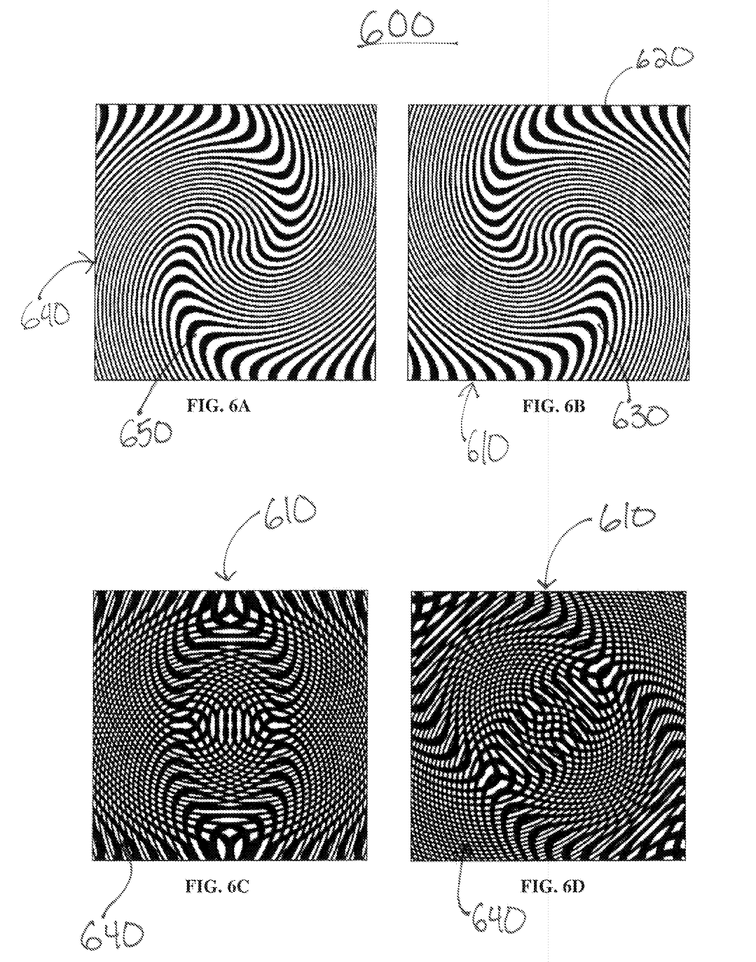

For example, FIGS. 6A-6D illustrate another exemplary embodiment of a display system 600 of the present invention. In one aspect, FIG. 6A shows a display device 640 having an image 650 comprising a plurality of curved lines of varying widths. In a further aspect, FIG. 6B shows a screening device 610 comprising a plurality of alternating image filter elements 620 and transparent image pass through elements 630, wherein the screening device is configured as a mirror image of the image of the display device. In a further aspect, FIG. 6C shows the screening device 610 of FIG. 6B selectively positioned in a first configuration relative to the display device 640 FIG. 6A such that a first image is produced through the transparent image pass through element. In a still further aspect, FIG. 6D shows the screening device 610 of FIG. 6C rotated 90° and selectively positioned in a second configuration relative to the display device 640 such that a second image is produced through the transparent image pass through element.

In other aspects, the display device has a plurality of “n” images disposed on a surface thereof. In further aspects, the screening device can be selectively positioned in at least n different configurations such that in each of the “n” different configurations one of the “n” images is viewable through the transparent pass through element and the remaining “n”−1 images is not viewable through the transparent pass through element.

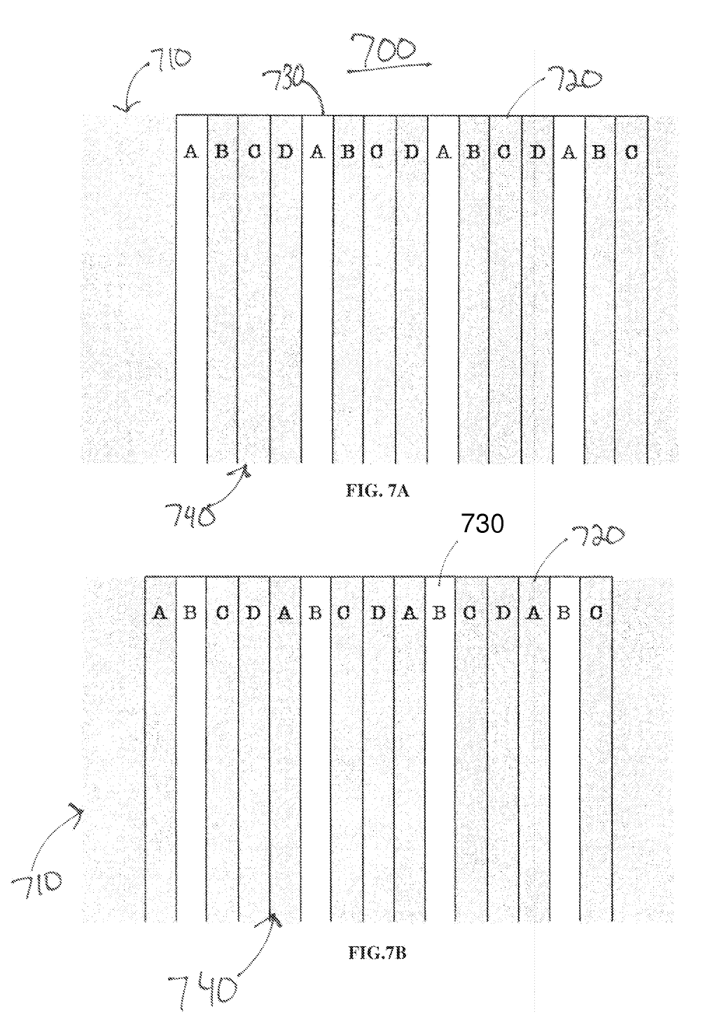

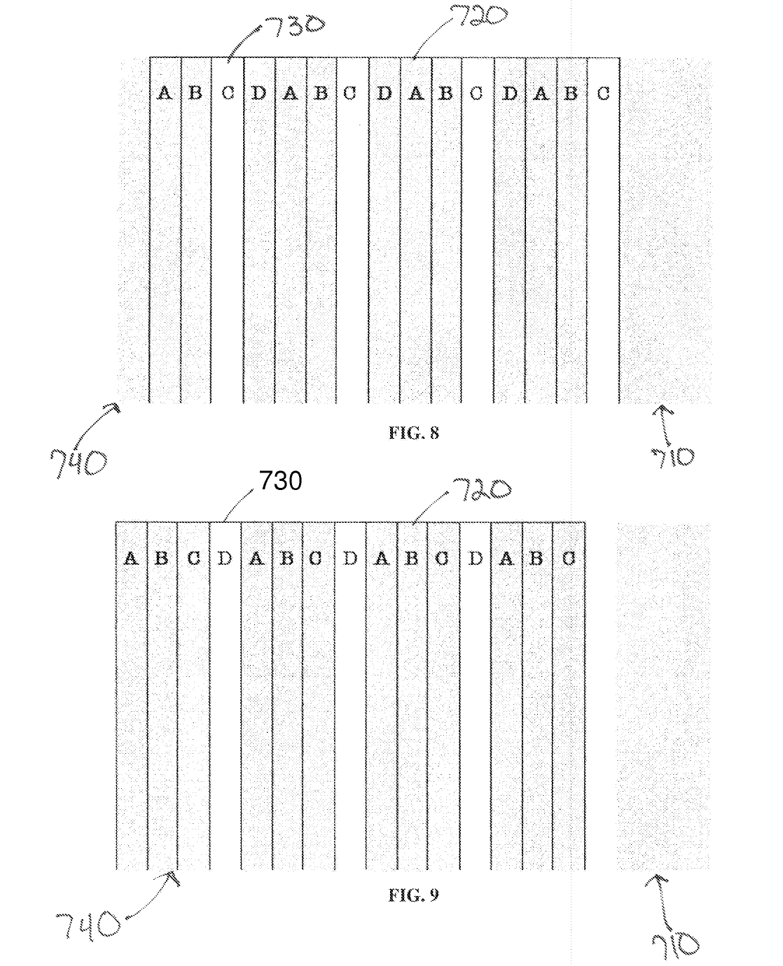

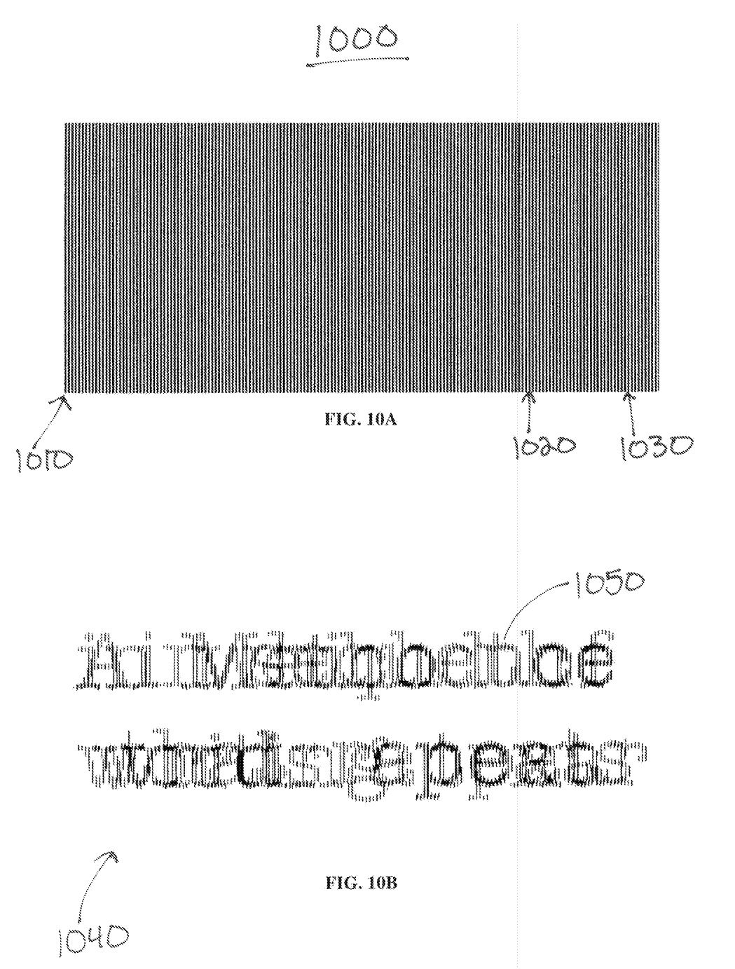

Referring now to FIGS. 7A-9, another aspect of an exemplary display system 700 of the present invention is illustrated. For example, in one aspect and similar to that aspect illustrated in FIG. 5, FIG. 7A shows a magnified view of the screening device 710 positioned over the display device 740 in a first configuration such that only the portion of the letter “A” is revealed through the transparent image pass through element 730, and the remaining letters are covered by the image filter element 720. In a further aspect, FIG. 7B shows a magnified view of the screening device 710 positioned over the display device in a second configuration such that only the portion of the letter “B” is revealed through the transparent image pass through element 730, and the remaining letters are covered by the image filter element 720. In a yet further aspect, FIG. 8 shows a magnified view of the screening device 710 positioned over the display device 740 in a third configuration such that only the portion of the letter “C” is revealed through the transparent image pass through element 730, and the remaining letters are covered by the image filter element 720. In an even further aspect, FIG. 9 shows a magnified view of the screening device 710 positioned over the display device 740 in a fourth configuration such that only the portion of the letter “D” is revealed through the transparent image pass through element 730, and the remaining letters are covered by the image filter element 720. While in the present embodiment the display device shows four images, according to other aspects of the disclosure, the display device can have a plurality of “n” images disposed on a surface thereof. In further aspects, the screening device can then be selectively positioned in at least n different configurations such that in each of the “n” different configurations one of the “n” images is viewable through the transparent pass through element and the remaining “n”−1 images is not viewable through the transparent pass through element.

In further aspects, the image filter element is identical to the image disposed on a surface of the display device. In still further aspects, the image filter element comprises an identically sized mirror image of the image disposed on a surface of the display device. In various aspects, the source images used to produce the composite image is text, symbols, logos, or marks, or combinations thereof. In some aspects, the composite images is interlaced to scramble or hide the text. In other aspects, the text in each source images is the same, while the background are different, such that the same word appears in each different configuration.

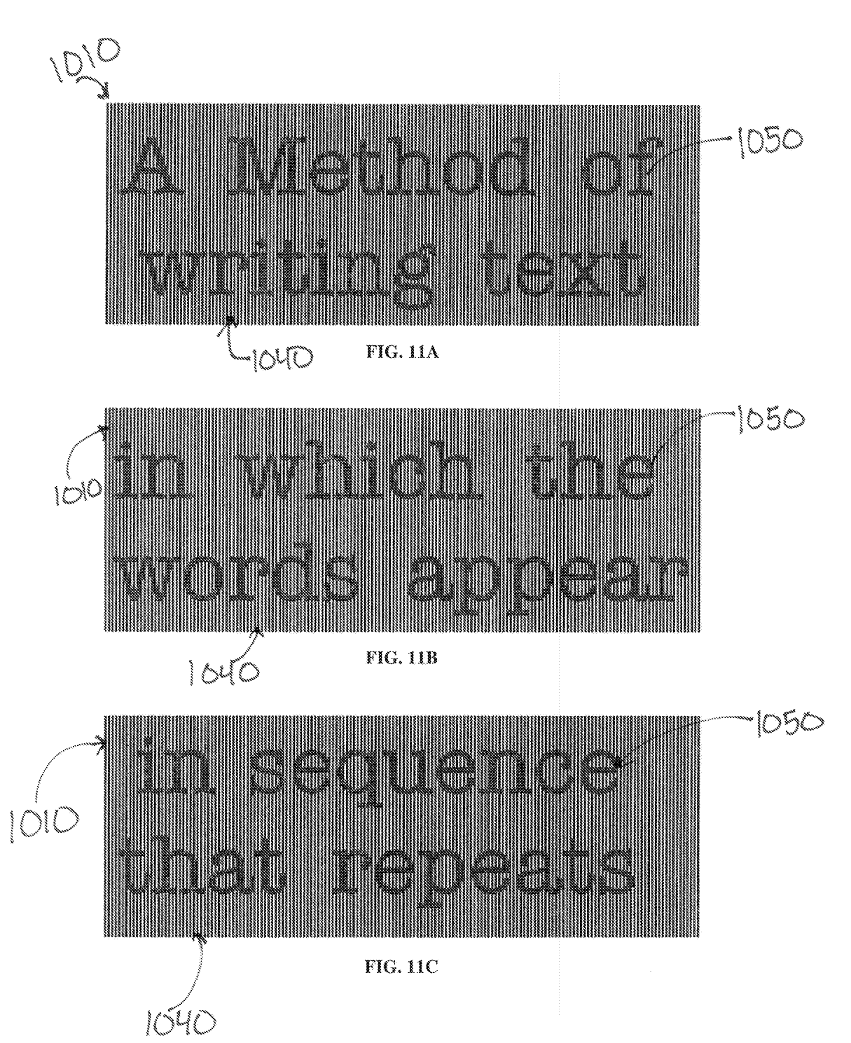

Now referring to FIGS. 10A and 10B, another exemplary embodiment of a display system 1000 of the present invention is shown. In one aspect, FIG. 10A shows a screening device 1010 comprising a plurality of alternating image filter elements 1020 and transparent image pass through elements 1030. In a further aspect, FIG. 10B shows a display device 1040 having an interlaced composite image 1050 comprised of scrambled text comprising three interlaced textual messages.

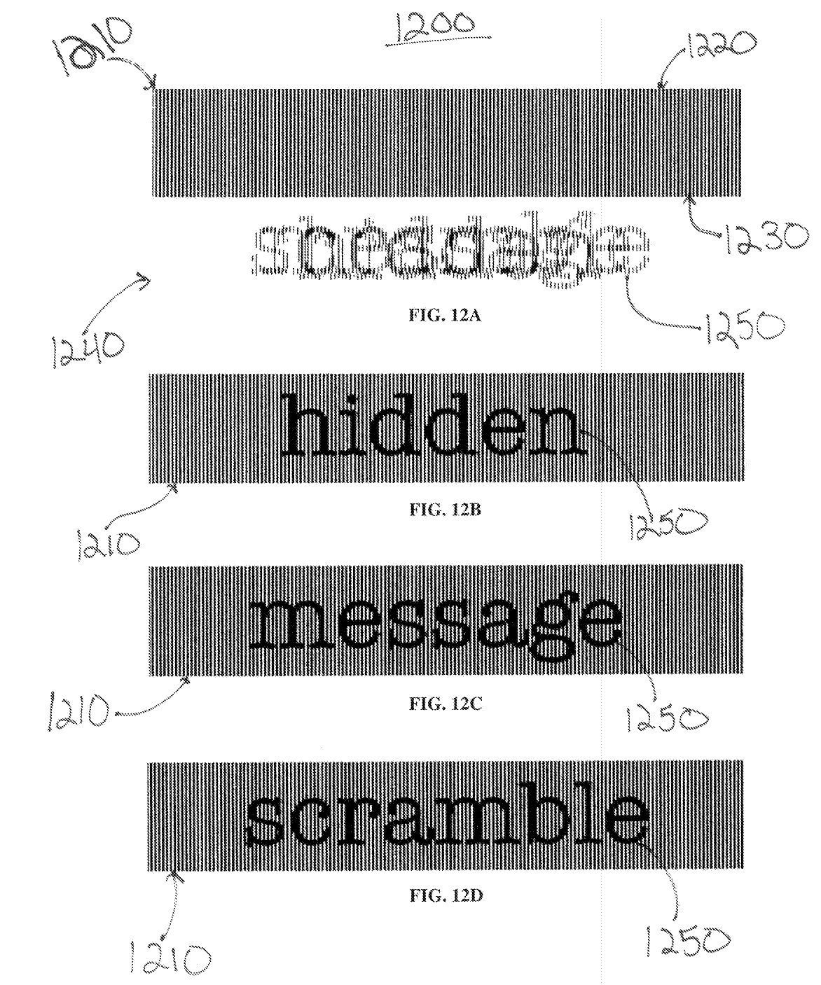

FIGS. 11A-11C illustrate additional aspects of the exemplary display system 1000 in use. In one aspect, FIG. 11A shows the screening device 1010 selectively positioned in a first configuration with respect to display device 1040 such that only the portion of the first textual message “A Method of writing text” of composite image 1050 is viewable through the transparent image pass through elements. In a further aspect, FIG. 11B shows the screening device 1010 selectively positioned in a second configuration relative to display device 1040 such that only the portion of a second textual message “in which the words appear” of composite image 1050 is viewable through the transparent image pass through element. In a still further aspect, FIG. 11C shows the screening device 1010 selectively positioned in a third configuration relative to the display device 1040 such that only the portion of a third textual message “in sequence that repeats” of composite image 1050 is viewable through the transparent image pass through element.

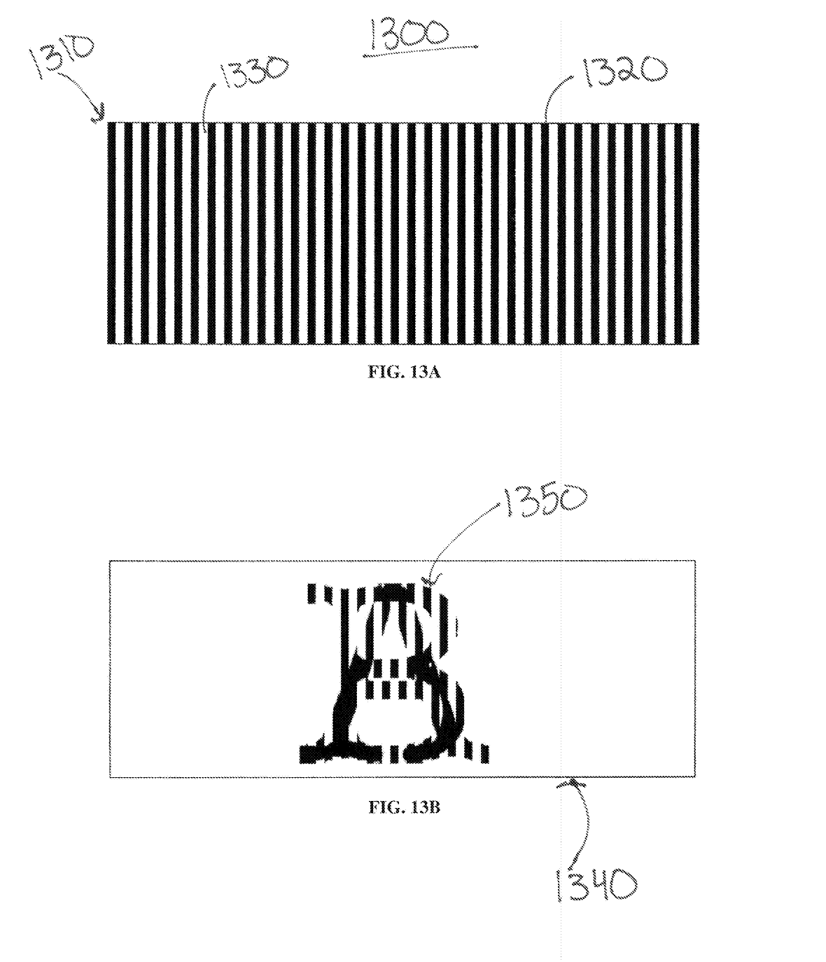

Now referring to FIGS. 12A-12D, an additional exemplary embodiment of a display system 1200 of the present invention is shown. In one aspect, FIG. 12A shows a screening device 1210 (top) comprising a plurality of alternating image filter elements 1220 and transparent image pass through elements 1230, and a display device 1240 (bottom) having a composite image 1250 of scrambled text comprising three interlaced words comprising the word “hidden”, the word “message”, and the word “scramble”. In a further aspect, FIG. 12B shows the screening device 1210 selectively positioned in a first configuration such that only the portion of the first word “hidden” of the composite image 1250 is revealed through the transparent image pass through element. In a further aspect, FIG. 12C shows the screening device 1210 selectively positioned in a second configuration such that only the portion of the second word “message” of the composite image 1250 is revealed through the transparent image pass through element. In a still further aspect, FIG. 12D shows the screening device 1210 selectively positioned in a third configuration such that only the portion of the third word “scramble” of the composite image 1250 is revealed through the transparent image pass through element.

In some aspects, the image is fixed on a planar surface of the display device. In other aspects, the image is disposed on a planar surface of the display device and the screening device is planar. In further aspects, the interlaced image disposed on a planar surface of the display device is non-planar and the screening device is non-planar. In yet further aspects, the screening device is spaced a predetermined distance from the planar surface in a parallel plane. In still further aspects, the image is disposed on a three dimensional surface of the display device.

In other aspects, the display device is cylindrical and the image is disposed on a cylindrical surface of the display device. In further aspects, the screening device is a sleeve, sized and shaped to receive the cylindrical display device. In yet further aspects, the screening device can be rotationally positioned in a second configuration such that a second desired portion of the image is viewable through the transparent image pass through element.

In some aspects, the screening device is in contact with the surface of the display device having the image disposed thereon. In other aspects, the screening device is releasably affixed to the surface of the display device.

In further aspects, the image is comprised of a plurality of equally spaced parallel lines of substantially identical width and wherein transparent image pass through element of the screening device is comprised of a plurality of equally spaced parallel transparent regions having a width and parallel spacing equal to that of the image such that in the first configuration the image is viewable through the transparent image pass through element. In still further aspects, the display device comprises at least two images, wherein the first image is comprised of a plurality of equally spaced parallel lines of substantially identical width, wherein the second image is comprised of a second plurality of equally spaced parallel lines of substantially identical width, and wherein the transparent image pass through element of the screening device is comprised of a plurality of equally spaced parallel transparent regions having a width and parallel spacing equal to that of the first and second image such that in the first configuration the first image is viewable through the transparent image pass through element and in a second configuration the second image is viewable through the transparent image pass through element.

As one of skill in the art can appreciate, the present invention can be used in a number of suitable applications where visual impact is important. In further aspect, the present systems and methods can be advantageously used in any field where visual appeal and interest are critical. In a still further aspect, by being able to display a plurality of image using a single composite image, systems and methods of the present invention allows for the production of an article with dynamic visual appeal and interest. In a further aspect, non-limiting examples of applications that the disclosed systems and methods can be used in include product packaging, product displays, wall coverings, books, and beverage containers.

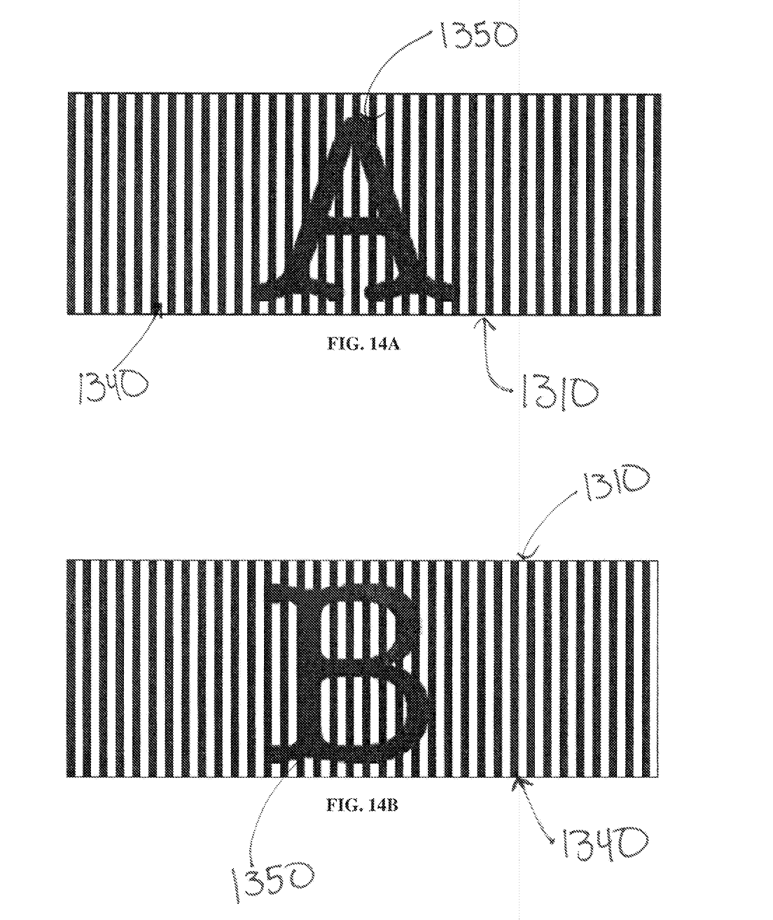

In one aspect, FIGS. 13A and 13B illustrate an exemplary embodiment of a display system 1300 of the present invention that can be used, for example, as a product packaging. In one aspect, FIG. 13A shows a screening device 1310 comprising a plurality of alternating image filter elements 1320 and transparent image pass through elements 1330, which is suitable for use, for example, as an outer label prior to application on the product package. In a further aspect, FIG. 13B shows a display device 1340 having a composite image 1350 comprising an image of the letter “A” interlaced with an image of the letter “B,” which is depicted as a product label prior to application on the product package.

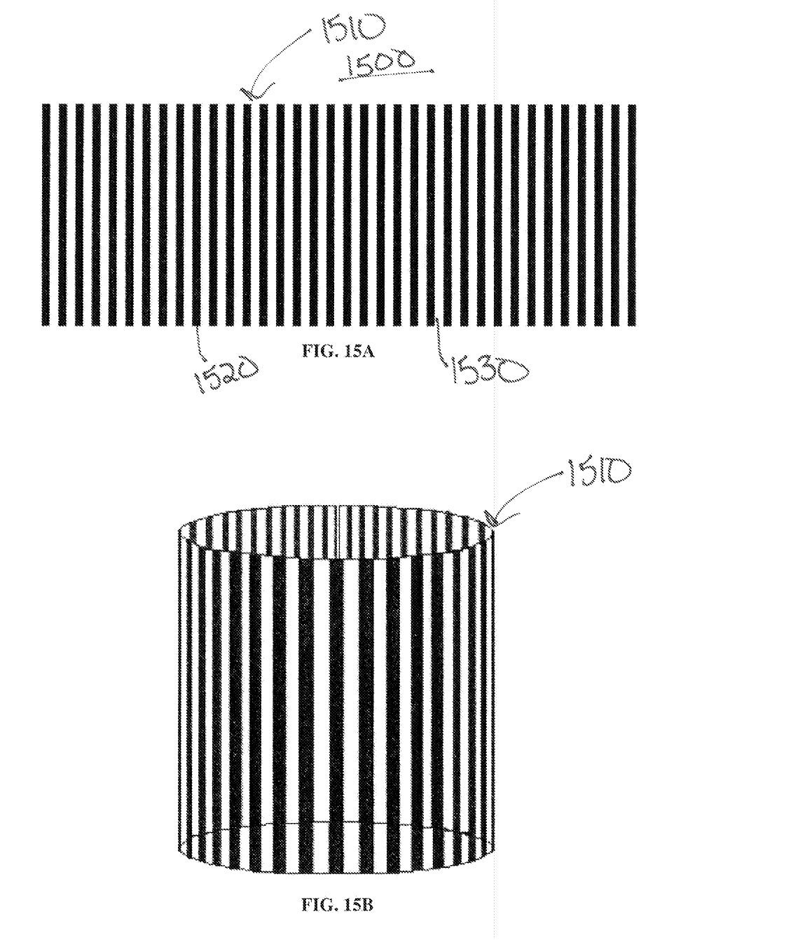

FIGS. 14A and 14B illustrate additional aspects of display device 1300 in use, for example, as product packaging. In one aspect, FIG. 14A shows the screening device 1310 label selectively positioned over the display device 1340 in a first configuration such that only the letter “A” portion of the label or composite image 1350 is viewable through the transparent image pass through element. In a further aspect, FIG. 14B shows the screening device 1310 label selectively positioned over the display device 1340 in a second configuration such that only the letter “B” portion of the label or composite image 1350 is viewable through the transparent image pass through element.

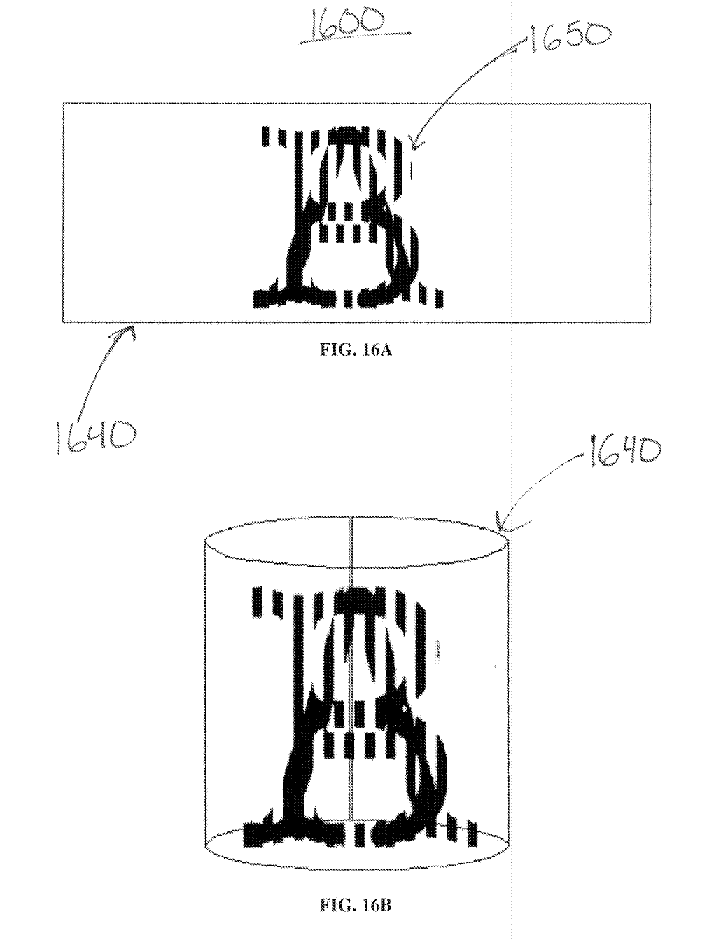

FIGS. 15A and 15B illustrate additional aspects of an exemplary embodiment of a screening device 1510 of the present invention, similar to that described above and that is suitable for use as product packaging. In one aspect, FIG. 15A shows a screening device 1510 comprising a plurality of alternating image filter elements 1520 and transparent image pass through elements 1530, which is shown as the outer label prior to application on the product package. In a further aspect, FIG. 15B shows the screening device 1510 configured as a sleeve, which is sized and shaped to receive, for example, a cylindrical shaped display device (not shown).

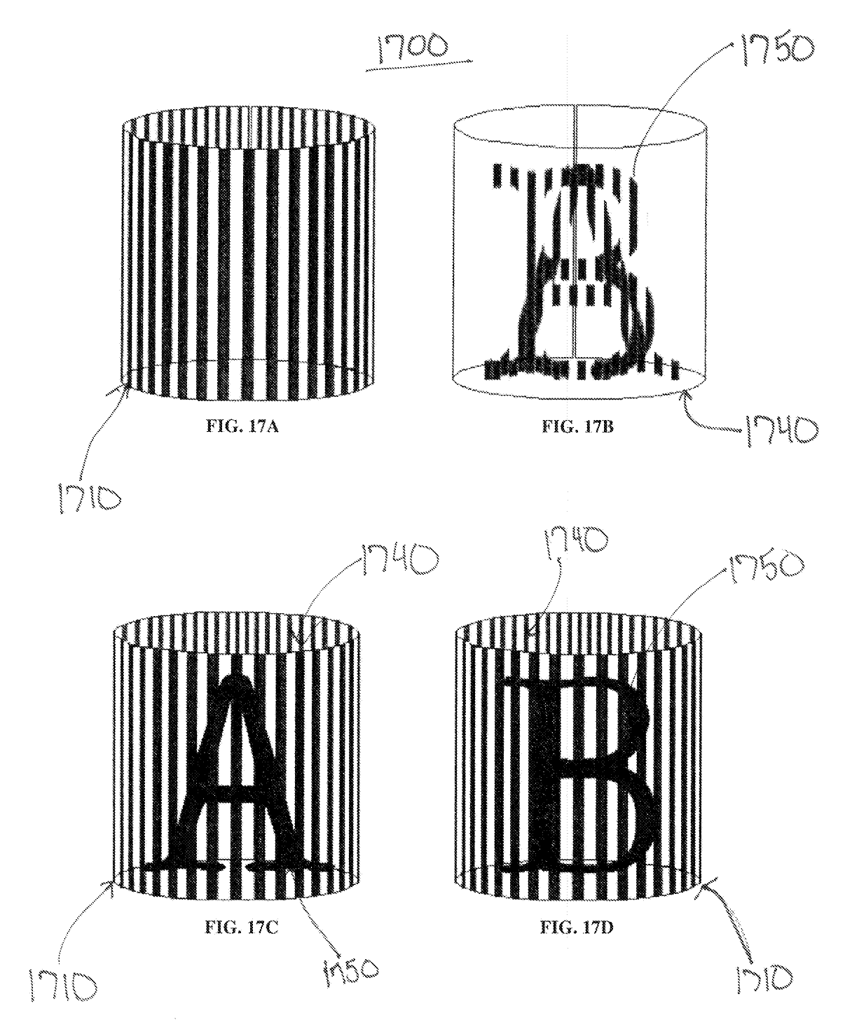

FIGS. 16A and 16B illustrate additional aspects of an exemplary embodiment of the display system of the present invention for use as product packaging. In one aspect, FIG. 16A shows a display device 1640 having a composite image 1650 comprising an image of the letter “A” interlaced with an image of the letter “B,” which is shown as a product label prior to application on the product package. In a further aspect, FIG. 16B shows the display device 1640 configured in a cylindrical shape such that the composite image is disposed on a cylindrical surface of the display device, which is sized and shaped to insert into or otherwise be received within, for example, the screening device shown in FIG. 15B.

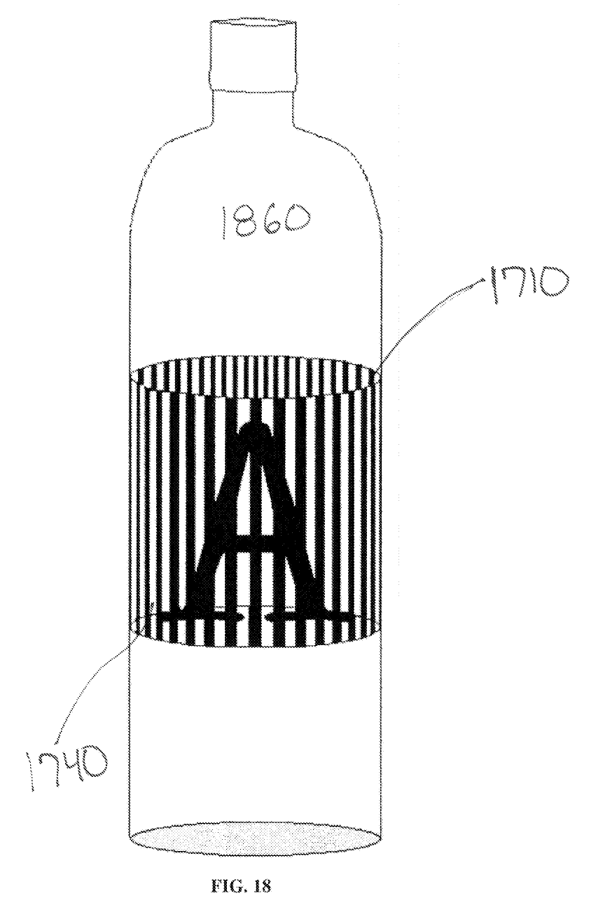

FIGS. 17A-17D illustrate another exemplary embodiment of a display system 1700 of the present invention suitable for use as product packaging. In one aspect, FIG. 17A shows the screening device 1710 configured as a sleeve, which is sized and shaped to receive a cylindrical display device 1740, shown in FIG. 17B. In a further aspect, FIG. 17B shows the display device 1740 configured in a cylindrical shape and the composite image 1750 disposed on a cylindrical surface of the display device 1740, which is sized and shaped to insert into the screening device 1720 shown in FIG. 17A. In a still further aspect, FIG. 17C shows the screening device 1710 label of FIG. 17A selectively positioned over the display device 1740 of FIG. 17 B in a first configuration such that only the letter “A” portion of the image or label 1750 is viewable through the transparent image pass through element. In a further aspect, FIG. 17D shows the screening device 1710 label of FIG. 17A selectively positioned over the display device 1740 of FIG. 17B in a second configuration such that only the letter “B” portion of the image or label 1750 is viewable through the transparent image pass through element.

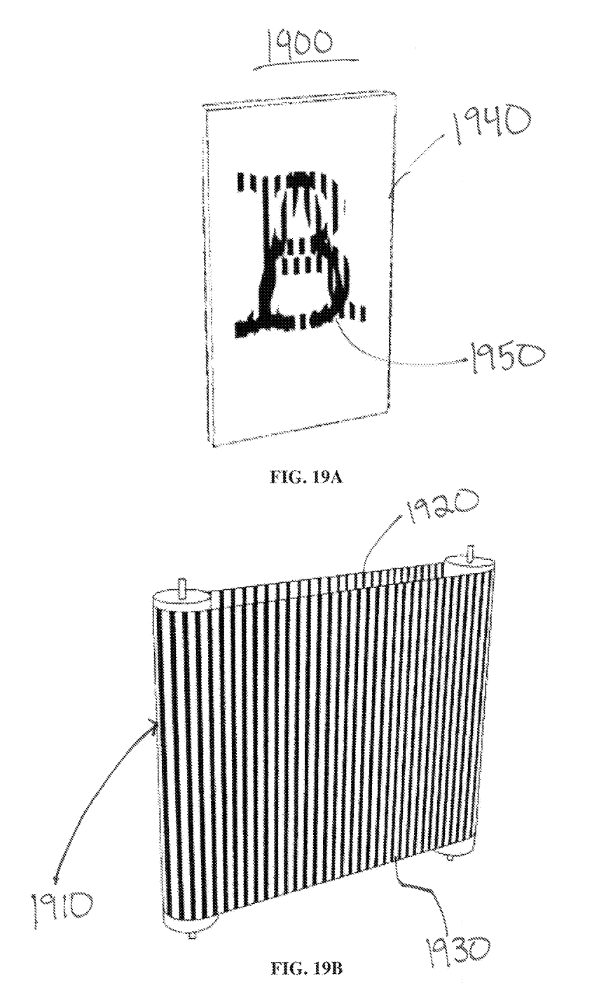

FIG. 18 illustrates another exemplary embodiment of a display system of the present invention for use as bottle packaging. In one aspect, FIG. 18 shows a screening device label 1710 as illustrated in FIGS. 17A-D configured as a sleeve selectively positioned over a display device 1740 as also illustrated in FIGS. 17A-D configured in a cylindrical shape and the image disposed on a cylindrical surface of the display device, in a configuration such that only the letter “A” portion of the label is viewable through the transparent image pass through element. As shown, both the display device 1740 and screening device 1710 can be applied to a product or article of manufacture, for example, the bottle 1860 as shown. In a further aspect, the screening device can be releasably affixed to the surface of the display device, such that the screening device is capable of rotating any desired degree of rotation, up to and including 360° about the display device. In a still further aspect, the viewer can rotate the screening device such that a desired interlaced letter is selectively viewable from the interlaced composite image. In a yet further aspect, the viewer can tilt or orient the bottle such that a desired interlaced letter is selectively viewable from the interlaced composite image.

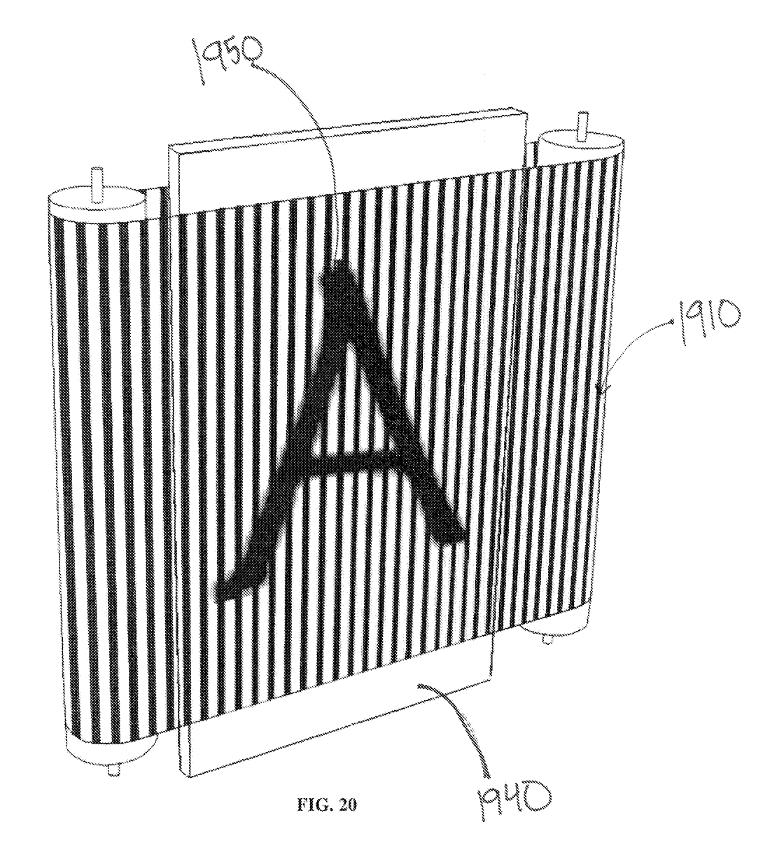

In some aspects, the system can be used as display, for conveying information to the viewer. FIGS. 19A and 19B illustrate an exemplary embodiment of a display system 1900 of the present invention that can, in one aspect, be used as a product display. In one aspect, FIG. 19A shows a display device 1940 having a composite image 1950 comprising an image of the letter “A” interlaced with an image of the letter “B.” In a further aspect, FIG. 19B shows a scrolling screening device 1910 comprising a plurality of alternating image filter elements 1920 and transparent image pass through elements 1930. In one aspect, the display device shown in FIG. 19A can comprise a light box having an image disposed on a surface thereof, for example, printed on a surface thereof. In other aspects, the display device can comprise a monitor, a video screen, or a computing device, such as for example, a tablet or laptop.

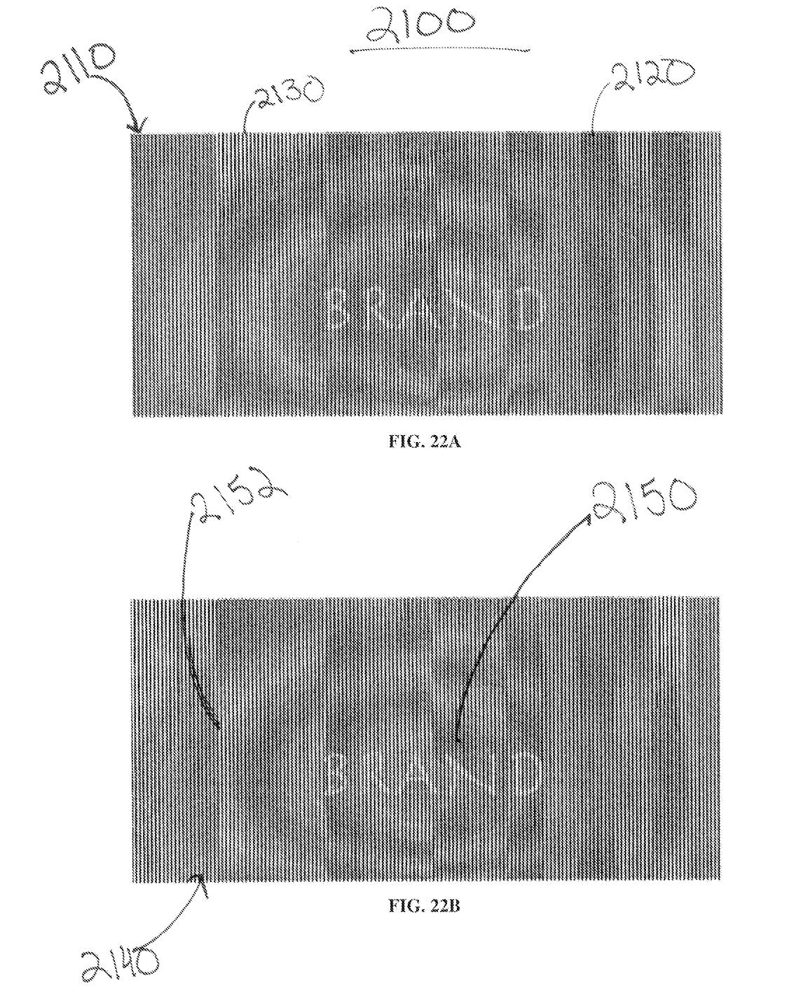

FIG. 20 illustrates the exemplary display system 1900, as described above, in use. In one aspect, FIG. 20 shows the scrolling screening device 1910 of FIG. 19A positioned concentrically around and spaced a predetermined distance from the surface of the display device 1940 of FIG. 19B. In a further aspect, FIG. 20 shows the scrolling screening device 1910 selectively positioned in a configuration such that only the letter “A” portion of the interlaced composite image 1950 is viewable through the transparent image pass through element. In still further aspects, the scrolling screening device is configured such that the scrolling screening device is continuously rotating around the display device. In yet further aspects, the observer viewing the display device can sequentially visualize each interlaced image selectively viewable from the interlaced composite image. In even further aspects, the scrolling screening device can be configured to switch positions in a predetermined sequence and rate, such that each corresponding image is displayed in rapid sequence. In still further aspects, the rapid switching between positions can impart a sense of movement to the viewer. In some aspects, the display device can be lighted or brightly colored. In other aspects, the display device can have an image disposed on a front surface and a back surface, such that display device is viewable from both sides.

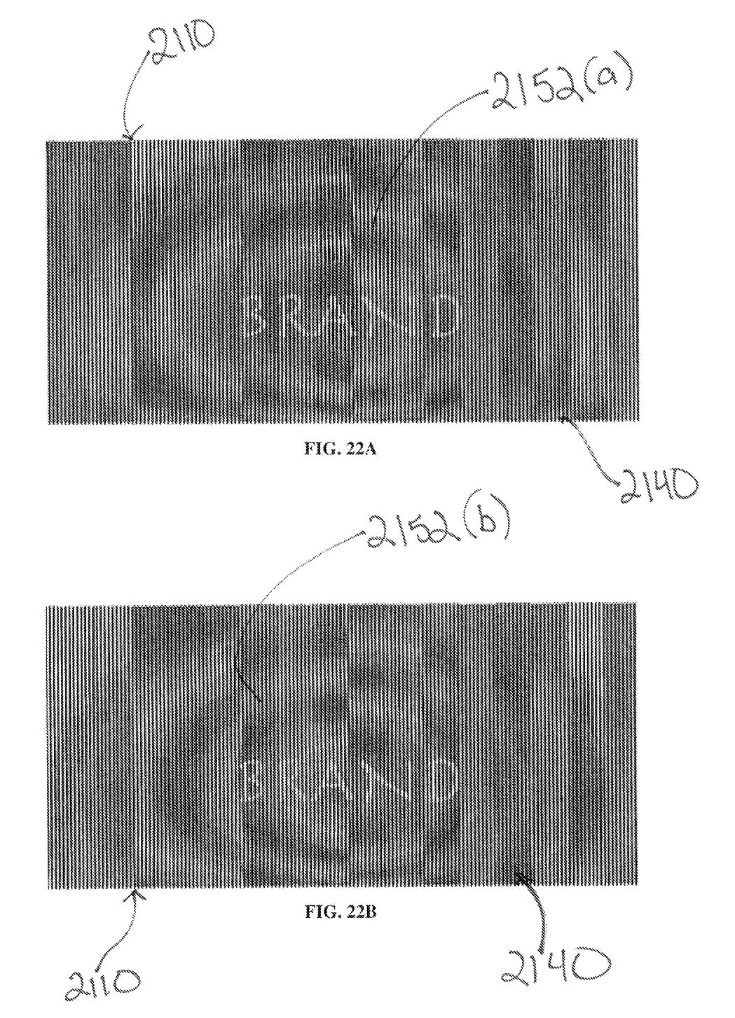

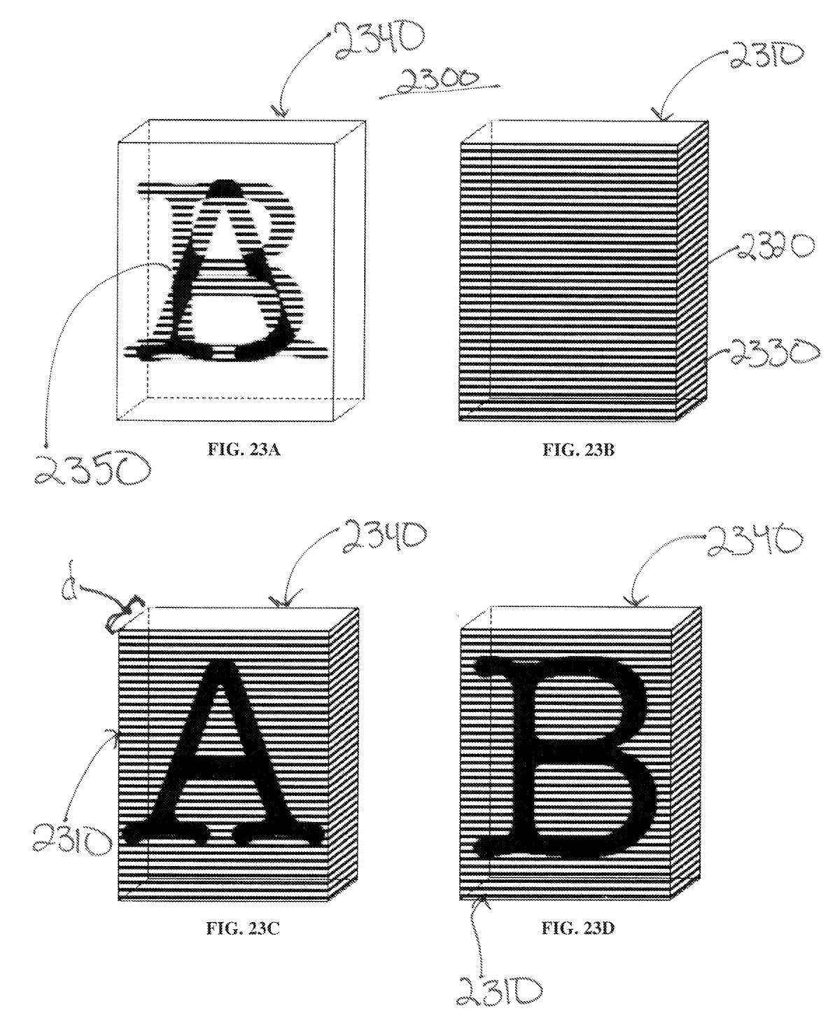

Referring to FIGS. 21A and 21B, another exemplary embodiment of a display system 2100 of the present invention is shown, which can, in some aspects, again be used for product packaging. In one aspect, FIG. 21A shows a screening device 2110 comprising a plurality of alternating image filter elements 2120 and transparent image pass through elements 2130, which is depicted as an outer product label prior to application on a product package (not shown). In a further aspect, FIG. 21B shows a display device 2140 having a composite image 2150 comprising two interlaced images, which is depicted as a product label prior to application on the product package (not shown). In a still further aspect, the composite image 2150 comprises the word “BRAND”, such that the word “BRAND” is viewable from the interlaced composite image through the transparent image pass through element in all positional configurations of the screening device. In a yet further aspect, while the word “BRAND” remains viewable, the screening device is selectively positioned between a first and second configuration such that only the background portion 2152 of the image appears to change. In an even further aspect, rapid switching between the positions can also impart a sense of movement in background behind the word “BRAND” to the viewer. For example, in one aspect, FIG. 22A shows the screening device label 2110 selectively positioned over the display device 2140 in a first configuration such that the word “BRAND” having a first background 2152a is viewable through the transparent image pass through element. In a further aspect, FIG. 22B shows the screening device 2110 label selectively positioned over the display device 2140 in a second configuration such that the word “BRAND” having a second background 2152b is viewable through the transparent image pass through element.

In various aspects, the image filter element and image pass through element of the screening device can have any desired orientation. For example, according to some aspects, the image filter element and image pass through element of the screening device have a vertical orientation. In other aspects, the image filter element and image pass through element of the screening device have a horizontal orientation. In further aspects, the composite image disposed on the surface of the display device can have any desired orientation. For example, in some aspects, the composite image on the display devise is disposed on the surface in a vertical orientation. In other aspects, the composite image on the display devise is disposed on the surface in a horizontal orientation.

In various aspects, the screening device and display device can be positioned at any desired distance relative to one another. According to aspects of the disclosure, the screening device and the display device can be positioned directly on top of one another. For example, in further aspects, the screening device can be directly adhered or laminated to a surface of the display device. In still further aspects, the display device comprising image can be directly adhered or laminated to a surface of the display device.

In further aspects, the screening device can be positioned a predetermined distance “d,” from the display device. In still further aspects, the display device can be positioned a predetermined distance “d,” from the screening device. In a further aspect, the distance “d” can be any desired distance, for example, 1 mm, 1 cm, 1 inch, 1 foot, 1 meter, 1 yard, 1 kilometer, 1 mile, or more. In a still further aspect, the distance “d” can be in a range between any two of the foregoing exemplary distances, for example, from about 1 mm to about 1 meter, or from about 1 inch to about 1 yard.

In various aspects, the display device or screening device can each independently be fixably attached or releasably affixed. In further aspects, the screening device and the display device can comprise the same substrate. For example, according to some aspects, the screening device can be fixably attached to a surface of a substrate, and the display device can be fixably attached to a surface of the same substrate. As one of skill in the art can appreciate, the screening device should be affixed a sufficient distance “d,” from the display device, such that filtering an image in a composite image of the display device is still possible. In a further aspect, the substrate can have a sufficient thickness such that when a screening device is fixably attached to a surface of the substrate, and a display device is fixably attached to a surface of the same substrate, the substrate can be tilted or oriented such that a desired image is selectively viewable from an interlaced composite image. In a still further aspect, the substrate can comprise any desired substrate, for example, the wall of a product package or a window, or the like.

According to aspects of the present disclosure, the screening device can be fixably attached to the display device, such that the viewer can tilt or orient the display device such that a desired image is selectively viewable from an interlaced composite image. In other aspects, the screening device can be releasably affixed to the surface of the display device, such that the screening device is capable of being moved about the display device such that a desired image is selectively viewable from an interlaced composite image. In further aspects, the display device or screening device can be fixably attached or releasably affixed by any desired attaching means or affixing means. In still further aspects, the attaching means can comprise gluing, adhering, laminating, printing, painting, or the like. In yet further aspects, the affixing means can comprise magnets, clips, fasteners, static electricity, or the like.

In various aspects, the image filter element of the screening device can be opaque. In further aspects, the image filter element of the screening device can comprise any desired level of opacity. In some aspects, the image filter element can be completely opaque, for example, having a level of opacity such that substantially no light is allowed to pass through the image filter element. In other aspects, the image filter element can be less than completely opaque, for example, having a level of opacity such some light is allowed to pass through the image filter element. In further aspects, the image filter element has a higher level of opacity than the image pass through element. In still further aspects, the image filter element has a sufficient level of opacity to selectively filter a sufficient degree of an image such that the non-filtered image is sufficiently viewable from an interlaced composite image.

In various aspects, the image filter element of the screening device can be transparent. In further aspects, the image filter element of the screening device can comprise any desired level of transparency. In some aspects, the image filter element can be completely transparent, for example, having a level of transparency such that substantially all light is allowed to pass through the image filter element. In other aspects, the image filter element can be less than completely transparent, for example, having a level of transparency such some light is allowed to pass through the image filter element. In further aspects, the image filter element has a lower level of transparency than the image pass through element. In still further aspects, the image filter element has a sufficient level of transparency to selectively filter a sufficient degree of an image such that the non-filtered image is sufficiently viewable from an interlaced composite image.

In various aspects, the image filter element of the screening device can comprise any desired color. In some aspects, the image filter element can be black. In other aspects, the image filter element can be red. In further aspects, the image filter element portion of the screening device can be a color that is matched to a color of the image portion of the display device. For example, in some aspects, the image filter element portion of the screening device is red, and at least one image of an composite image of display device is red. In still further aspects, the screening device is not a lenticular lens.

In further aspects, the screening device and display device can each independently have any desired form or shape. For example, according to some aspects, the screening device can be flat or have a flat shape and the display device can be flat or have a flat shape. In other aspects, the screening device can be curved or have a curved shape and the display device can be curved or have a curved shape. In further aspects, the screening device can be curved or have a curved shape and the display device can be flat or have a flat shape. In still further aspects, the screening device can be flat or have a flat shape and the display device can be curved or have a curved shape. In yet further aspects, the curved shape can be convex or concave. For example, and without limitation, the screening device can be concave and the display device can be convex.

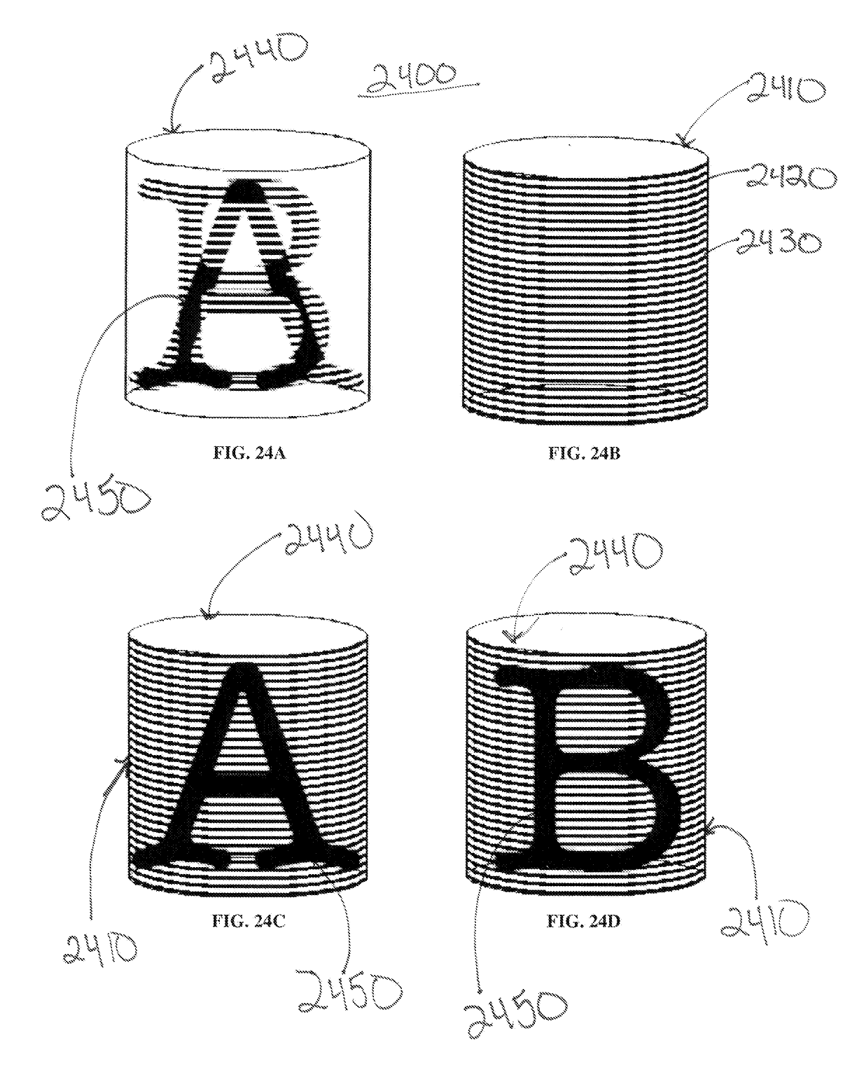

Referring to FIGS. 23A-23D, another exemplary embodiment of a display system 2300 of the present invention is illustrated, which can again, in some aspects, be used for product packaging. In one aspect, FIG. 23A shows a display device 2340 having a horizontally orientated composite image 2350 comprising an image of the letter “A” interlaced with an image of the letter “B”, which is depicted as product packaging prior to positioning of a screening device. In a further aspect, FIG. 23B shows a screening device 2310 comprising a plurality of horizontally orientated alternating image filter elements 2320 and transparent image pass through elements 2330, which is depicted as product packaging prior to positioning of a display device having a composite image. In a still further aspect, FIG. 23C shows the screening device 2310 selectively positioned a distance “d” from the display device in a first configuration such that only the portion of the letter “A” image is viewable through the transparent image pass through element. In a yet further aspect, FIG. 23D shows an alternative perspective, where the screening device 2310 is selectively positioned a distance “d” from the display device 2340 in a second configuration such that only the portion of the letter “B” image is viewable through the transparent image pass through element. In one aspect, the position of the screening device is selected and determined by the perspective of the viewer and spatial relationship to the screening device.

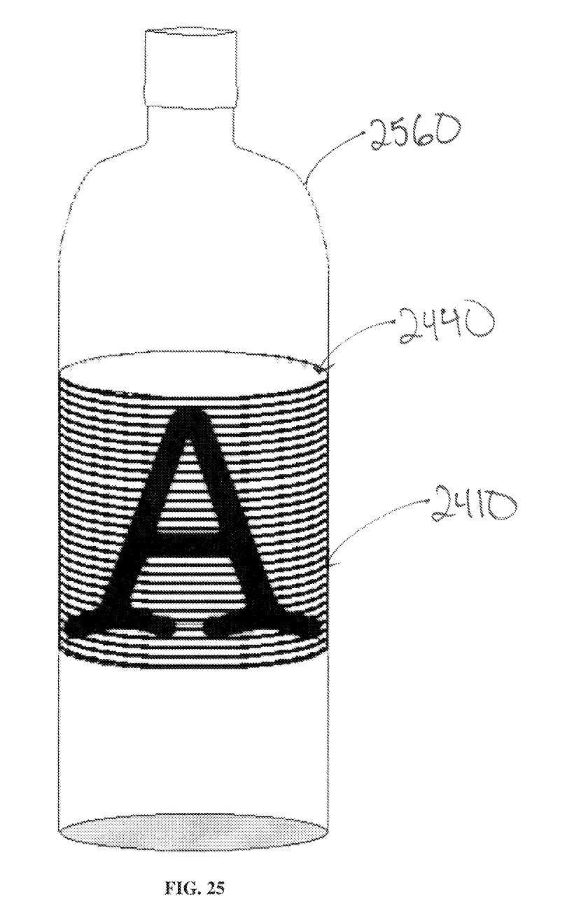

Referring to FIGS. 24A-24D, another exemplary embodiment of a display system 2400 of the present invention is illustrated, which can again, in some aspects, be used for product packaging. In one aspect, FIG. 24A shows a display device 2440 having a horizontally orientated, composite image 2450 comprising an image of the letter “A” interlaced with an image of the letter “B”, which is depicted on the surface of a product label prior to positioning of a screening device. In a further aspect, FIG. 24B shows a screening device 2410 comprising a plurality of horizontally orientated, alternating image filter elements 2420 and transparent image pass through elements 2430, which is depicted on a surface of an outer product label prior to positioning over the display device 2440 having the composite image 2450. In a still further aspect, FIG. 24C shows the screening device 2410 selectively positioned around the display device 2440 in a first configuration such that only the portion of the letter “A” image is viewable through the transparent image pass through element. In a yet further aspect, FIG. 24D shows an alternative perspective, where the screening device 2410 is selectively positioned around the display device 2440 in a second configuration such that only the portion of the letter “B” image is viewable through the transparent image pass through element. In one aspect, the position of the screening device is selected and determined by the perspective of the viewer and spatial relationship to the screening device.

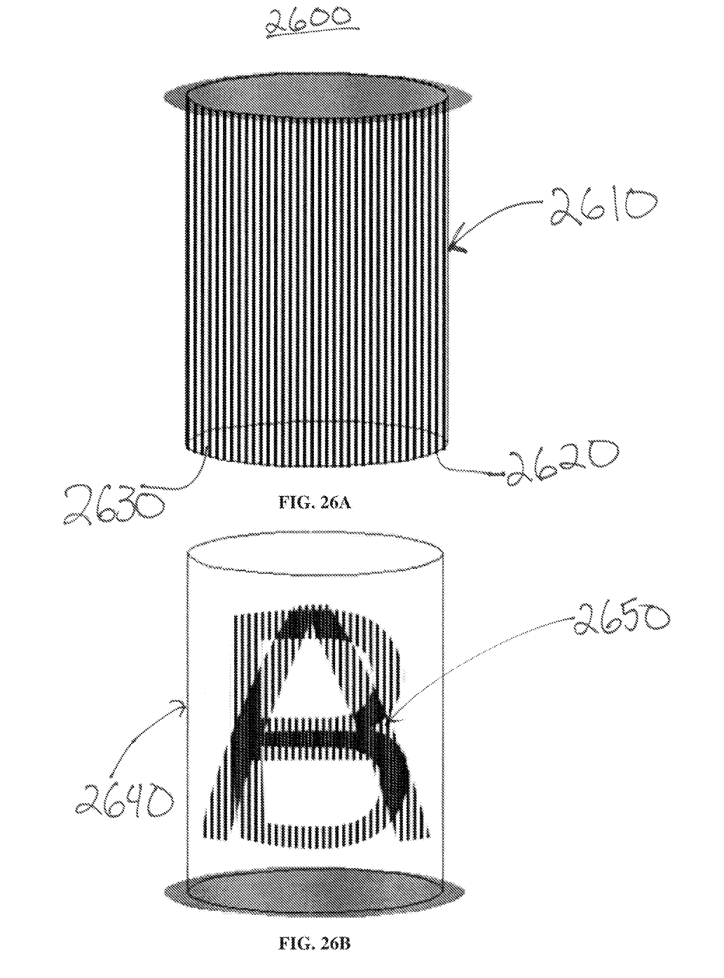

FIG. 25 illustrates another exemplary embodiment of a display system of the present invention for use as bottle packaging. Specifically, FIG. 25 shows system 2400 as illustrated in FIGS. 24A-D configured as a sleeve or product label for a cylindrical article such as a bottle 2560. As shown, the screening device 2410 is selectively positioned over the display device 2440 in a configuration such that only the letter “A” portion of the label is viewable through the transparent image pass through elements. In another aspect, the display device can be fixably attached to the bottle. In a further aspect, the screening device can be releasably affixed to the surface of the display device, such that the screening device is capable of being moved up and down the display device. In a still further aspect, the viewer can move the screening device such that a desired interlaced letter is selectively viewable from the interlaced composite image. In a yet further aspect, the viewer can tilt or orient the bottle such that a desired interlaced letter is selectively viewable from the interlaced composite image.

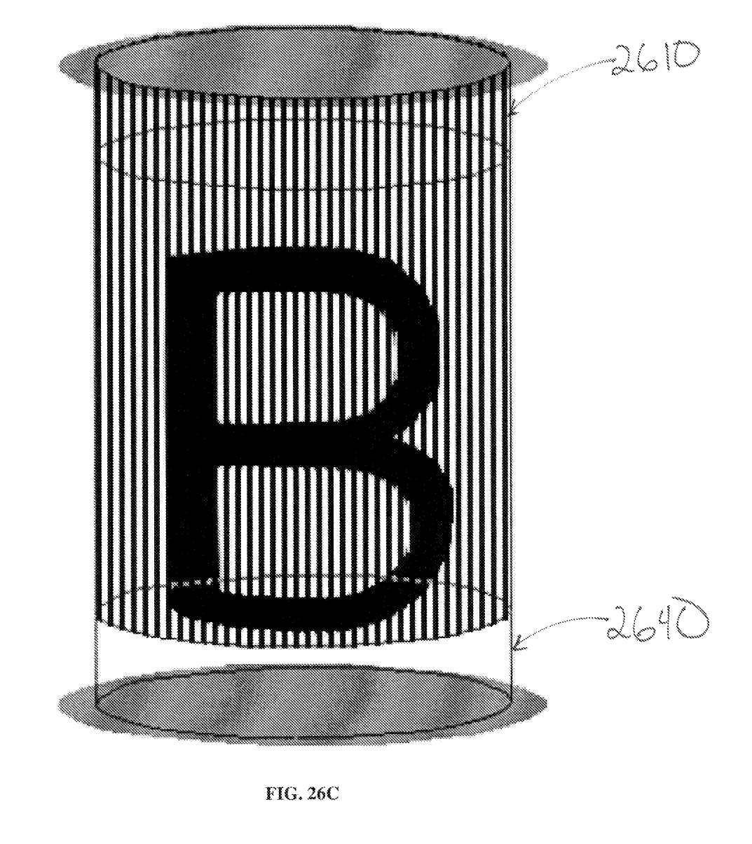

Referring to FIGS. 26A-26C, another exemplary embodiment of a display system 2600 of the present invention is illustrated, which can again, in some aspects, be used for product packaging. In one aspect, FIG. 26A shows a screening device 2610 comprising a plurality of alternating image filter elements 2620 and transparent image pass through elements 2630, which is depicted as outer product packaging prior to positioning over a display device 2640 having a composite image 2650. In a further aspect, FIG. 26B shows a display device 2640 having a composite image 2650 comprising an image of the letter “A” interlaced with an image of the letter “B”, which is depicted as inner product packaging prior to positioning of a screening device. In a still further aspect, FIG. 26C, which is depicted as outer product packaging positioned over inner product packaging, shows the screening device 2610 selectively positioned over the display device 2650 in a first configuration such that only the portion of the letter “B” image is viewable through the transparent image pass through element. In a yet further aspect, the viewer can rotate the screening device about the display device such that a desired interlaced letter is selectively viewable from the interlaced composite image. In an even further aspect, the viewer can move the product packaging such that a desired interlaced letter is selectively viewable from the interlaced composite image. As shown, the system can be configured in any desired shape and configuration, such as the illustrated cylindrical configuration where the screening device and display device each form a portion of a cylindrical enclosure. To this end, it should be understood the packaging or enclosure can be configured in other shapes and sizes such as cubes, or elongated or rectangular shaped boxes.

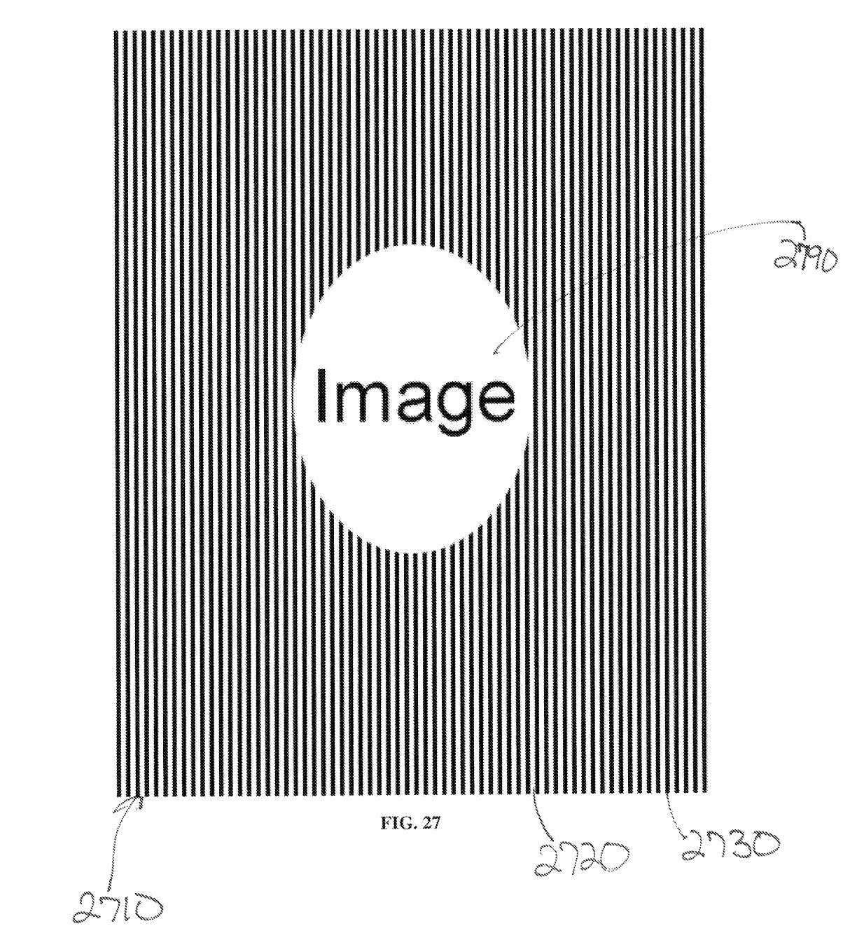

In various aspects, the screening device can further comprise a fixed image disposed on a surface thereof. In one aspect, FIG. 27 shows an exemplary screening device 2710 comprising a plurality of alternating image filter elements 2720 and transparent image pass through elements 2730, and a fixed image 2790. As one of ordinary skill will appreciate, when the screening device comprising a fixed image is positioned over a display device, the screening device can be selectively positioned such that the desired background and desired image is selectively viewable from the interlaced composite image, while the fixed image remains viewable at all times.

In various aspects, the present display systems can effectively associate or link one or more images to one or more other images to a viewer. For example, in one aspect, each of the interlaced image will be associated with each of the other interlaced images in the composite image of the display device. In a further aspect, the fixed image on the screening device will be associated with each of the interlaced images in the composite image of the display device.

As described herein, the present display systems can be configured to impart a sense of movement to the viewer. In a further aspect, the image displayed by the display system can switch between images in the interlaced composite at a rapid rate. In a still further aspect, the viewer's position and movement about the display device can determine the image displayed and the switching rate between the different images of the composite image. For example, the display system can be positioned close to the viewer to cause rapid switching between images as the viewer moves by the display device. In a yet further aspect, the proximity of the viewer to the display system and the rapid rate of switching between images can impart a sense of blending of the images of the composite images. In a further aspect, the rate at which the images switch can be decreased as the distance from display device is increased. For example, the display system can be positioned farther away from the viewer to cause a decrease in the rate of switching between images as the viewer moves by the display device.

### C. METHODS FOR DISPLAYING AN IMAGE

In various aspects, the present invention also relates to a method for displaying an image. In a further aspect, the present invention provides a method for displaying an image, the method comprising: a) providing a display device having an image disposed on a surface thereof; and b) overlying a screening device on at least a portion of the display device; wherein the screening device comprises an image filter element and a transparent image pass through element, and wherein the screening device can be selectively positioned in a first configuration such that a desired portion of the image is viewable through the transparent image pass through element.

In various aspects, the screening device can be positioned in multiple configuration positions. In further aspects, each configuration position can produce a different visual image. For example, according to still further aspects, the screening device can be selectively positioned in a second configuration such that a second desired portion of the image is viewable through the transparent image pass through element. In yet further aspects, the screening device can be selectively positioned in a second configuration such that a desired portion of the image is not viewable through the transparent image pass through element.

In some aspects, display device can comprise a composite image comprising at least two images. In further aspects, the display device can comprise at least three images. For example, in still further aspects, the display device can have at least two visual images disposed on a surface thereof and wherein the screening device can be selectively positioned in a first configuration such that a first of the at least two images is viewable through the transparent image pass through element and a second of the at least two images is not viewable through the transparent image pass through element. In a yet further aspect, the screening device can be selectively positioned in a second configuration such that the second of the at least two images is viewable through the transparent image pass through element the first of the at least two images is not viewable through the transparent image pass through element.

In further aspects, the composite image comprises at least two images, wherein the at least two images are interlaced. In still further aspects, any number of a plurality of images can be interlaced to provide a composite image. In yet further aspects, the composite image is disposed on a surface of the display device.

In other aspects, the composite image comprises at least one fixed image and at least one video image. For example, in further aspects, the display device can have at least one fixed image interlaced with at least one video disposed on a surface thereof and wherein the screening device can be selectively positioned in a first configuration such that the at least one fixed image is viewable through the transparent image pass through element and the at least one video image is not viewable through the transparent image pass through element. In a yet further aspect, the screening device can be selectively positioned in a second configuration such that the at least one video image is viewable through the transparent image pass through element and the at least one fixed image is not viewable through the transparent image pass through element. In an even further aspect, the video image is not static, and will change based on the video format and/or frame rate.

In further aspects, each of the plurality of interlaced images can then be made viewable by selectively positioning the screening device such that a desired interlaced image is selectively viewable from the interlaced composite image. In still further aspects, the selected image is made viewable through the transparent pass through element and the remaining interlaced images are not viewable through the transparent pass through element. In yet further aspects, selectively positioning comprises subjecting the interlaced composite image to a plurality of transparent image pass through elements, each of which are preselected to reveal a desired source image.

In some aspects, the screening device configuration position can be switched in a sequence of configuration positions causing a corresponding images to be displayed in rapid sequence. In further aspects, the rapid switching between configuration positions can impart a sense of movement to the viewer. In other aspects, the display device and screening device can remain fixed and a viewer's position can cause a corresponding image to be displayed by the screening device. In further aspects, the rapid change of the viewer's position can also cause switching between configuration positions, also impart a sense of movement to the viewer.

In various aspects, the image filter element of the screening device can be opaque. In further aspects, the image filter element of the screening device can comprise any desired level of opacity. In some aspects, the image filter element can a level of opacity such that substantially no light is allowed to pass through the image filter element. In other aspects, the image filter element can have a level of opacity such some light is allowed to pass through the image filter element. In further aspects, the image filter element has a higher level of opacity than the image pass through element. In still further aspects, the image filter element has a sufficient level of opacity to selectively filter a sufficient degree of an image such that the non-filtered image is sufficiently viewable from an interlaced composite image.

In various aspects, the image filter element of the screening device can comprise any desired color. In some aspects, the image filter element can be black. In other aspects, the image filter element can be red. In further aspects, the image filter element portion of the screening device can be a color that is matched to a color of the image portion of the display device. For example, in some aspects, the image filter element portion of the screening device is red, and at least one image of an composite image of display device is red. In still further aspects, the screening device is not a lenticular lens.

In other aspects, the display device has a plurality of “n” images disposed on a surface thereof. In further aspects, the screening device can be selectively positioned in at least n different configurations such that in each of the “n” different configurations one of the “n” images is viewable through the transparent pass through element and the remaining “n”−1 images is not viewable through the transparent pass through element.

In further aspects, the image filter element is identical to the image disposed on a surface of the display device. In still further aspects, the image filter element comprises an identically sized mirror image of the image disposed on a surface of the display device.

In some aspects, the image is fixed on a planar surface of the display device. In other aspects, the image is disposed on a planar surface of the display device and the screening device is planar. In further aspects, the interlaced image disposed on a planar surface of the display device is non-planar and the screening device is non-planar. In yet further aspects, the screening device is spaced a predetermined distance from the planar surface in a parallel plane. In still further aspects, the image is disposed on a three dimensional surface of the display device.

In other aspects, the display device is cylindrical and the image is disposed on a cylindrical surface of the display device. In further aspects, the screening device is a sleeve, sized and shaped to receive the cylindrical display device. In yet further aspects, the screening device can be rotationally positioned in a second configuration such that a second desired portion of the image is viewable through the transparent image pass through element.

In some aspects, the screening device is in contact with the surface of the display device having the image disposed thereon. In other aspects, the screening device is releasably affixed to the surface of the display device.

In further aspects, the image is comprised of a plurality of equally spaced parallel lines of substantially identical width and wherein transparent image pass through element of the screening device is comprised of a plurality of equally spaced parallel transparent regions having a width and parallel spacing equal to that of the image such that in the first configuration the image is viewable through the transparent image pass through element. In still further aspects, the display device comprises at least two images, wherein the first image is comprised of a plurality of equally spaced parallel lines of substantially identical width, wherein the second image is comprised of a second plurality of equally spaced parallel lines of substantially identical width, and wherein the transparent image pass through element of the screening device is comprised of a plurality of equally spaced parallel transparent regions having a width and parallel spacing equal to that of the first and second image such that in the first configuration the first image is viewable through the transparent image pass through element and in a second configuration the second image is viewable through the transparent image pass through element.

In some aspects, the plurality of lines comprising an interlaced image are not equally spaced or parallel. In further aspects, the interlaced composite image can comprise at least a first image comprising a plurality of curved lines of varying widths. In other aspects, the screening device is a mirror image of the image of the display device.

As described herein, the present methods of displaying images can be configured to impart a sense of movement to the viewer. In a further aspect, the image displayed by the method can switch between images in the interlaced composite at a rapid rate. In a still further aspect, the viewer's position and movement about the device can determine the image displayed and the switching rate between the different images of the composite image. For example, the device can be positioned close to the viewer to cause rapid switching between images as the viewer moves by the display device. In a yet further aspect, the proximity of the viewer to the device and the rapid rate of switching between images can impart a sense of blending of the images of the composite image. In a further aspect, the rate at which the images switch can be decreased as the distance from device is increased. For example, the device can be positioned farther away from the viewer to cause a decrease in the rate of switching between images as the viewer moves by the display device.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein can be different from the actual publication dates, which can require independent confirmation.

The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system comprising,
(a) a display device having an image disposed on a surface thereof; and
(b) a screening device overlying at least a portion of the display device and comprising an image filter element and a transparent image pass through element;
wherein the screening device can be selectively positioned in a first configuration such that a desired portion of the image is viewable through the transparent image pass through element.

2. The system of claim 1, wherein the screening device can be selectively positioned in a second configuration such that a second desired portion of the image is viewable through the transparent image pass through element.

3. The system of claim 1, wherein the screening device can be selectively positioned in a second configuration such that a desired portion of the image is not viewable through the transparent image pass through element.

4. The system of claim 1, wherein the display device has at least two images disposed on a surface thereof and wherein the screening device can be selectively positioned in a first configuration such that a first of the at least two images is viewable through the transparent image pass through element and a second of the at least two images is not viewable through the transparent image pass through element.

5. The system of claim 4, wherein the screening device can be selectively positioned in a second configuration such that the second of the at least two images is viewable through the transparent image pass through element and the first of the at least two images is not viewable through the transparent image pass through element.

6. The system of claim 5, wherein the at least two images are interlaced.

7. The system of claim 1, wherein the display device has a plurality of “n” images disposed on a surface thereof and wherein the screening device can be selectively positioned in at least n different configurations such that in each of the “n” different configurations one of the “n” images is viewable through the transparent pass through element and the remaining “n”−1 images is not viewable through the transparent pass through element.

8. The system of claim 7, wherein the display device comprises at least three interlaced images.

9. The system of claim 1, wherein the image filter element is opaque.

10. The system of claim 1, wherein the image filter element is transparent.

11. The system of claim 1, wherein the image filter element is identical to the image disposed on a surface of the display device.

12. The system of claim 1, wherein the image filter element comprises an identically sized mirror image of the image disposed on a surface of the display device.

13. The system of claim 1, wherein the image is disposed on a planar surface of the display device and the screening device is planar.

14. The system of claim 13, wherein the screening device is spaced a predetermined distance from the planar surface in a parallel plane.

15. The system of claim 1, wherein the image is disposed on a three dimensional surface of the display device.

16. The system of claim 1, wherein the display device is cylindrical and the image is disposed on a cylindrical surface of the display device.

17. The system of claim 17, wherein the screening device is a sleeve sized and shaped to receive the cylindrical display device.

18. The system of claim 17, wherein the screening device can be rotationally positioned in a second configuration such that a second desired portion of the image is viewable through the transparent image pass through element.

19. The system of claim 1, wherein the screening device is in contact with the surface of the display device having the image disposed thereon.

20. The system of claim 19, wherein the screening device is releasably affixed to the surface of the display device.

21. The system of claim 1, wherein the image is comprised of a plurality of equally spaced parallel lines of substantially identical width and wherein transparent image pass through element of the screening device is comprised of a plurality of equally spaced parallel transparent regions having a width and parallel spacing equal to that of the image such that in the first configuration the image is viewable through the transparent image pass through element.

22. The system of claim 21, wherein the display device comprises at least two images, wherein the first image is comprised of a plurality of equally spaced parallel lines of substantially identical width, wherein the second image is comprised of a second plurality of equally spaced parallel lines of substantially identical width, and wherein the transparent image pass through element of the screening device is comprised of a plurality of equally spaced parallel transparent regions having a width and parallel spacing equal to that of the first and second image such that in the first configuration the first image is viewable through the transparent image pass through element and in a second configuration the second image is viewable through the transparent image pass through element.

23. A method for displaying an image, the method comprising:
(a) providing a display device having an image disposed on a surface thereof; and
(b) overlying a screening device on at least a portion of the display device;
wherein the screening device comprises an image filter element and a transparent image pass through element, and
wherein the screening device can be selectively positioned in a first configuration such that a desired portion of the image is viewable through the transparent image pass through element.

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)
